(19) United States
(12) Patent Application Publication
(10) Pub. No.: US 2016/0058181 A1
(43) Pub. Date: Mar. 3, 2016

(54) Systems and Methods for Securing and Temperature Regulating a Delivery Container

(71) Applicant: Qing HAN, Coquitlam (CA)

(72) Inventors: Qing HAN, Coquitlam (CA); Sai Karun GURRAPPADI, Brampton (CA); Shin Kan Kent NG, Scarborough (CA); Peter Jiayu LIU, Guelph (CA); Knut Auvor GRYTHE, Mountain View, CA (US)

(73) Assignee: Qing HAN, Coquitlam (CA)

(21) Appl. No.: 14/476,177

(22) Filed: Sep. 3, 2014

(51) Int. Cl. A47B 81/00; A47F 10/02; E05B 39/00; E05B 41/00; G07C 9/00; E05B 49/00; E05B 65/00; F24F 11/00; H04N 5/225; A47B 71/00; E05B 43/00

(52) U.S. Cl. CPC A47B 81/00; A47B 71/00; A47F 10/02; E05B 39/005; E05B 41/00; E05B 43/005; E05B 49/00; E05B 65/0075; E05B 65/0042; F24F 11/0034; H04N 5/225; G07C 9/00126; A47F 2010/005

(57) ABSTRACT

A delivery container equipped with a lock device, temperature regulating device, sensors and a processor is configured to receive and further store goods without the presence of an owner. The owner is notified by a user device when a delivery is made. The door of the delivery container is opened when a valid passcode is entered. The temperature regulating device heats or cools the interior space of the container, whereby the temperature of the interior space may be automatically determined or manually adjusted. A user via a user device can also communicate with the delivery container to send delivery instructions. The processor of the container is configured to calculate cooling and heating rates and controls the overall operations of the delivery container.

### TECHNICAL FIELD

The following generally relates to storing and retrieving delivered goods. More specifically, a delivery container is provided that is equipped with a temperature regulator and a controller capable of communicating with a user device.

### BACKGROUND

Purchasing goods and further having the goods delivered to an address has become an increasingly popular method for consumers to shop. Consumers are able to purchase items such as clothes, shoes, furniture, appliances, food and groceries and have the goods delivered to a household or a business address. Shipping companies have thus attempted to facilitate the growing industry of household delivery. In some instances, goods can be purchased and subsequently delivered within days or even hours. As vendors continue to publish more content online, consumers are provided with a wide variety of options. Orders placed online, in a store, or via telephone can be quickly shipped to an address, even if the consumer is not available to immediately receive the order at the given address. As such, the goods can be delivered directly from a manufacturer, a warehouse or a store to a consumer.

Some items that are delivered include consumer goods. Some items do not need to be placed in a temperature regulated environment. However, other items that require a temperature regulated environment, for example perishable foods, are often not delivered unless the receiver and the deliverer can coordinate a delivery time. Otherwise, the consumer may return to the household only to retrieve food that is spoiled due to the lack of a temperature regulated environment. For example, food may spoil in hot temperatures, or hot food may become cold or stale.

To ensure security, many lock mechanisms have been developed, whereby a deliverer can place the purchased items into a secure container. The container is often placed external to the consumer's residence and access is only permitted to individuals provided with a key or code. The container facilitates the deliveries of goods when the consumer is not home at the time of the delivery.

### BRIEF DESCRIPTION OF DRAWINGS

Embodiments will now be described by way of example only with reference to the appended drawings wherein:

FIG. 1 is an example perspective view of a container with a door open;

FIG. 2 is a block diagram of an example configuration of a container system;

FIG. 3A and FIG. 3B is an example of a front view and a profile view respectively of a container;

FIG. 4 is an example view of the interior of a container;

FIG. 5 is another example view of the interior of a container;

FIG. 6 is an example perspective view of a container illustrating the divider slots;

FIG. 7 is an example perspective view of a container illustrating the adjustable divider units;

FIG. 8 is an example block diagram of data stored in a database of a controller of a container;

FIG. 9 is a flow diagram of an embodiment of a container system;

FIG. 10 is a flow diagram of example instructions executed and received by a user device, a container, a server and a third party device;

FIG. 11 is another flow diagram of example instructions executed and received by a user device, a container, a server and a third party device;

FIG. 12 is a flow diagram of example computer executable instructions for determining if temperature regulation is required after a delivery is received;

FIG. 13 is a flow diagram of example computer executable instructions to turn on and off a temperature regulating device;

FIG. 14 is a flow diagram of example computer executable instructions after receiving an expected delivery;

FIG. 15 is a flow diagram of example computer executable instructions to determine the heating and cooling process for an expected delivery;

FIG. 16 is a flow diagram of example computer executable instructions to calculate the heating and cooling rate;

FIG. 17 is a flow diagram of example computer executable instructions to generate a passcode and to set temperature regulation data;

FIG. 18 is a flow diagram of example computer executable instructions analyzing an entered passcode;

FIG. 19 is a flow diagram of example computer executable instructions to determine internal container temperature and to control the temperature regulating device;

FIG. 20 is an example graph of an internal temperature profile of a container;

FIG. 21 is a flow diagram of example computer executable instructions to determine if the weight on a divider has changed.

FIG. 22 is a flow diagram of example computer executable instructions to control a camera within a container and to analyze the images captured by a camera;

FIG. 23 is an example block diagram of executable instructions that can be performed by a user device; and

FIG. 24 is a screen shot of a home screen displayed on a user device.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Home owners and businesses are benefitting from the increasing online presence of retailers. Goods can be purchased online and delivered to an address within days or even hours after an order is placed. Predicting when a delivery is to arrive can be a challenging task. Delivery companies can project within a time period of several hours when a customer can expect a delivery. If the customer is unavailable to receive the delivery within the time period, the deliverer often leaves the package by the door, or attempts a subsequent delivery a following day. It is recognized that the package is vulnerable to theft if the delivery is left at the door. Therefore it is herein recognized that it is desirable to receive deliveries in a secure manner and to help a home owner and a business avoid having to wait for a delivery within the expected time period.

It is recognized that there may be times when it is desirable for a home owner or a business to communicate with a delivery container. The home owner or business may wish to relay important information regarding operating conditions to the container. For example, such information can include the expected time of delivery. It is also recognized that it may be desirable for the container to also communicate with a user's device to send notifications. For example, the notification can apprise a user when a delivery was successfully made, or the notification can include status updates. As such, without a communication method and system, a home owner or a business cannot remotely send and receive delivery information and other data.

It is also recognized that in some instances it is desirable to keep the contents of the delivery at a certain temperature to ensure that perishable products stay fresh. Examples of such deliveries can include groceries or prepared meals. Since there are few ways or ineffective ways to keep delivered food fresh, there is usually a limited selection of groceries appropriate for delivery when the customer is not present to receive the delivery. Therefore, temperature regulation in a delivery receiving container is desirable.

It is also recognized that existing cooling units, or heating units, or both, cannot control the situation of cooling or heating, and are not capable of determining when the temperature regulating device should be turned on or turned off. For example, once the cooling unit is turned on, the unit remains on until the unit is manually turned off. In other words, in many cases, a temperature regulating device is activated when it is not needed, or is not activated in time causes the delivered object to spoil. As such, energy efficiency problems arise since the temperature regulating device cannot be automatically controlled. Therefore, a method of automatic temperature regulation is desirable, where temperatures may be pre-set and a cooling unit, or a heating unit or both, may be controlled to improve energy efficiency.

In general, a system and a method are provided for receiving deliveries, and automatically setting the temperature of the receiving apparatus in anticipation of the delivery, or in response to the delivery, or both. In an example aspect, the receiving apparatus is a container capable of receiving and further storing goods. The container is equipped with a temperature regulating device and access controls. The container can be sized and shaped to fit the need of a home owner or a business. The container includes a temperature regulating unit, a communication device, a lock device and a controller. The container may include other systems and devices. The container is capable of controlling and further monitoring the internal temperature to facilitate the delivery of items that require temperature regulation, such as warm or cold food. The container can communicate with other devices to inform a user when a delivery has been made and to receive instructions from a user. The instructions can include delivery schedules and expected temperature profiles.

In an example embodiment, the container includes a cooling holding section in fluidic communication with a cooling unit, a heating holding section in fluidic communication with a heating unit, and a neutral holding section at ambient temperature for other goods stored therein. Each holding section is divided by a thermally insulated divider. The dividers are configured to be adjustable to change the size of the temperature regulated area. In an example embodiment, the neutral holding section is positioned between the cooling holding section and the heating holding section.

The container includes a lock device that controls access to the container. The lock device is configured to determine the validity of passcodes capable of unlocking or locking the container, or both. Each passcode may be associated with a time constraint and a constraint for the number of uses. A controller logs operational data associated with the container, including passcodes and temperature profiles, and may communicate with devices via a communication device. The communication device sends data and notifications to the devices, thereby alerting a user when a state of the container has changed. The communication device also receives data and commands from other devices, such as the user's device.

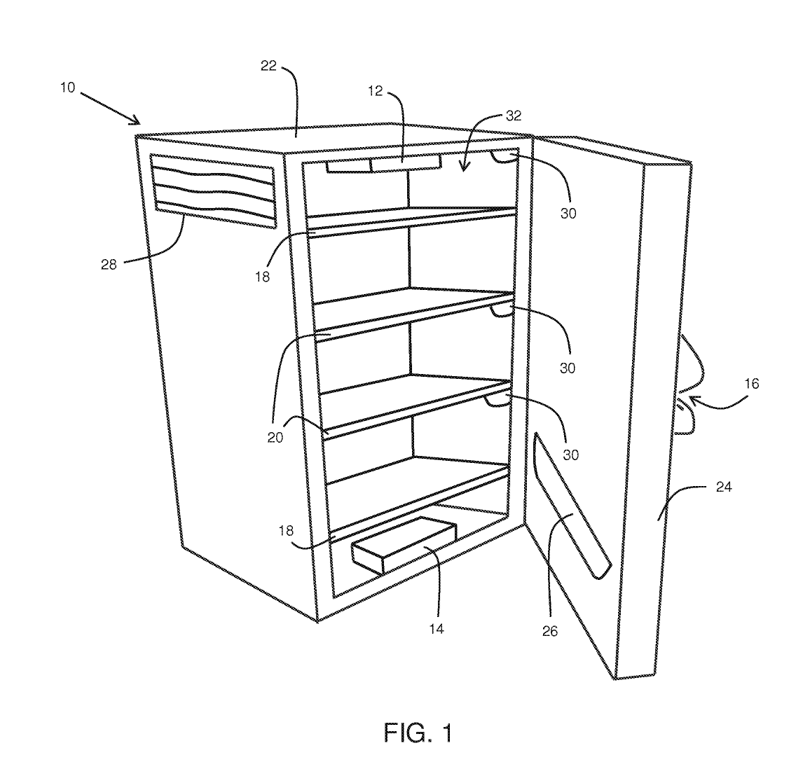

FIG. 1 shows an example embodiment of a container 10 with a door 24 open. The container 10 includes a supporting body 22 that defines an interior space 32 where goods can be placed. The interior of the supporting body 22 is thermally insulated to reduce heat transfer with the ambient environment. It will be appreciated that “ambient” (e.g. as used with ambient temperature and ambient environment) may be respectively interchanged with “external”. A temperature regulating device or devices include a cooling unit 12 and a heating unit 14 capable of cooling at least an upper section and heating at least a lower section respectively. It can be appreciated that the temperature regulating device or devices can be placed at different locations in the interior space 32 of the container 10. In an example embodiment, only a cooling unit is included, or only a heating unit is included, or both a cooling and a heating unit are included.

The sections are fully enclosed by thermally insulated walls. The upper section can include a freezer compartment and a refrigeration compartment, whereby the freezer compartment is at a lower temperature than the refrigeration compartment. One or more thermally insulated dividers 20 can divide the upper and lower sections to reduce heat transfer loss. Non-thermally insulated dividers 18 can also be included to facilitate the storing of items within the container 10. A middle section including a neutral holding section may be positioned between the upper and lower sections. The neutral holding section may be thermally insulated from the cooling area and the heating area, and as such is not affected by the temperature regulating device. In an example embodiment, also included within the interior space 32 of the container 10 are one or more video cameras 30. The video cameras 30 are operable to obtain video and pictures of contents within the container.

The cooling unit 12 and heating unit 14 are optionally included and are independently operable. In FIG. 1, the cooling unit 12 is configured at the top of the interior space 32 while the heating unit 14 is configured at the bottom. This is to make use of the natural occurrence that cold air falls and hot air rises. However, it will be appreciated that both the cooling unit 12 and the heating unit 14 can be placed at different locations in the container 10, and any number of cooling units 12 and heating units 14 can be included in the container 10. In another example embodiment, the cooling unit 12 can be placed under a non-thermally insulated divider 18. In yet another example embodiment, multiple cooling units 12, or multiple heating units 14, or multiples of both, are included. Those skilled in the art can appreciate that any combinations thereof may exist and embodiments described herein are provided by way of example.

One or more of the side walls of the container 10 may include a vent 28. The vent 28 facilitates the flow of external air to enter the interior space 32, or the flow of air from the interior space to exit to the external environment. The door 24 of the container 10 is also thermally insulated to prevent heat dissipation. In an example embodiment, the interior of the door 24 includes an interior receiving slot 26 to receive smaller items that do not require temperature regulation, such as mail. Since the interior receiving slot 26 is hollow, the slot is covered by a thermally insulated flap that reduces heat transfer loss. The exterior of the door 24 includes a lock device 16 for controlling entry into the container 10. Though not shown in FIG. 1, the exterior of the door 24 may also include indicator lights, a display device, user input devices and an exterior receiving slot. It will be appreciated that the physical configuration of the components of the container described herein are an example, and that components may be re-arranged, removed or added according to other example embodiments although not specifically described herein.

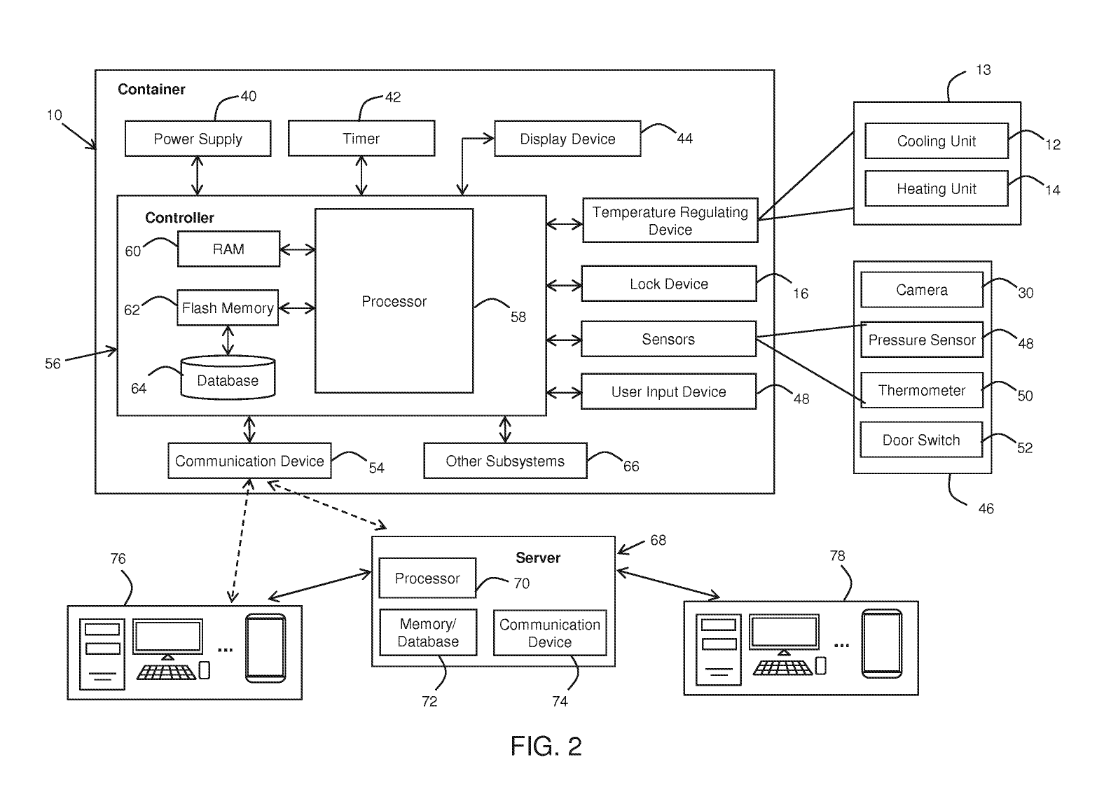

Referring to FIG. 2, to further aid in the understanding of the example container 10, shown therein is a block diagram of an example configuration of the electrical components of the container 10. The container 10 includes a number of components such as a controller 56 that controls the overall operation of the container 10. Other components capable of communicating with the controller 56 include a power supply 40, a timer 42, a display device 44, a temperature regulating device 13, a lock device 16, sensors 46, one or more user input devices 48, a communication device 54 and other subsystems 66. It will be appreciated that the timer 42 may be implemented as a separate timer device or through software executed by the controller 56.

The power supply 40 capable of converting alternating current (AC) to direct current (DC) supplies power to the container and its associated components. The timer 42 capable of at least recording elapsed time includes one or more of a clock, a stopwatch and a calendar. The display device 44 provides visual feedback to a user interacting with the container 10. The temperature regulating device 13 includes at least one of a cooling unit 12 and a heating unit 14. The lock device 16 controls access to the container 10 and restricts the opening of the door 24. Sensors 46 monitor the state of the container 10 and report pertinent information to the controller 56. The user input device 48 facilitates interactions with a user and may include buttons or may be integrated with other components such as the display device 44. The communication device 54 permits communication with other electronic devices. Other subsystems 66 may be included with the container 10 and may send information to and receive information from the controller 56. These subsystems can include data ports, speaker, microphone, status indicators, alarm, universal serial bus (USB), and etc.

In an example embodiment, the controller 56 interfaces with the other components, and includes a processor 58 that interacts with additional subsystems such as random access memory (RAM) 60, flash memory 62 and a database 64. The operating system and other software components to be executed by the controller 56 are typically stored in a persistent store such as the flash memory 62. Persistent data, as well as frequency accessed data such as passcodes, temperature data, connection information, rules and sensor data, is stored in the database 64 of the flash memory 62. Those skilled in the art can appreciate that data and applications may also be temporarily loaded into a volatile storage medium such as RAM 60.

Container 10 information may be shown via the display device 44. The information includes, for example, but is not limited to, the current internal temperatures of the internal compartments, the next expected delivery, the current status of the container 10, the owner of the container, the temperature of the external environment, whether a delivery was made, when the last delivery was made, and etc. The display device 44 may include currently known or future known technologies. Examples of display technology include liquid-color display (LCD), light-emitting diode (LED) display, and variants thereof. In one example, the display may be any suitable touch-sensitive display, such as capacitive, resistive, infrared, optical imaging, and so forth. One or more touches or touch gestures may be detected by the touch-sensitive display and the controller 56 may determine attributes of the touch, such as the location of the touch. A touch may be detected from any suitable object, such as a finger, thumb, appendage, or other items, for example, a stylus, pen, or another pointer device. In another example, the display device 44 may be a non-touch-sensitive display in place of, or in addition to a touch-sensitive display.

The temperature regulating device 13 receives instructions from the controller 56 and turns on or off the cooling unit 12 and the heating unit 14 as required. Temperature profiles and different cooling or heating rates may be executed by the temperature regulating device 13. Additional details regarding the temperature regulating device 13 are further disclosed in the proceeding figures.

The lock device 16 controls entry into the container 10 and notifies a user device 76 or a server 68 when the door 24 has opened. The lock device 16 includes a lock for locking the door 24, and an unlocking mechanism capable of releasing the lock. It can be appreciated that the lock may be a mechanical lock, an electromechanical lock, or other currently known or future known locks. In an example embodiment, the unlocking mechanism is an alphanumeric keypad operatively connected to the lock and configurable to receive inputs. Passcodes may be entered via the alphanumeric keypad and the lock is unlocked when a valid passcode is detected. Other unlocking mechanisms can be used in place of, or in addition to the alphanumeric keypad. Other unlocking mechanisms can include, for example, an RFID reader, a card reader, a fingerprint identification system, a voice recognition system, a biometric reader, a bar code reader, RF receiver, near field communication (NFC) receiver, gesture control sensor, or the like.

In an example embodiment, the container 10 includes a plurality of sensors. Non-limiting examples of sensors include a video camera 30, a pressure sensor 48, a thermometer 50, and a door switch 52. Other sensors may also be used. The video camera 30 is configured to capture live video or pictures of the interior or exterior of the container. The pressure sensors 48 are configured to record and track the changes in weight found on the dividers 18 and 20, or other surfaces on which the delivered items are placed. The thermometers 50 may be placed both inside and outside the container 10 and are capable of at least recording internal and external temperature respectively. In another example embodiment, a thermometer 50 is positioned to only measure the temperature of the internal space 32. The door switch 52 is configured to detect when the door 24 has been opened and closed. It can be appreciated that other sensors capable of detecting other parameters may be included in the container 10 and the above sensors are provided by way of example.

Communication functions are performed through one or more communication devices 54. The communication device 54 receives messages from and sends messages to a user device 76, or a central server 68, or both. In this example of the container 10, any one of wired or wireless communication interfaces may be used by the communication device 54, including short range network systems such as Bluetooth, Wi-Fi, Zigbee, radio frequency (RF) communication, etc. and long range network systems such as the Global System for Mobile Communication (GSM) standard, General Packet Radio Services (GPRS) standard, Third Generation (3G), Fourth Generation (4G) and Long Term Evolution (LTE). The long range network systems can be used in place of, or in addition to the short range network systems. New standards are still being defined, but it is believed that they will have similarities to the network behavior described herein, and it will also be understood by persons skilled in the art that the examples described herein are intended to use any other suitable standards that are developed in the future.

It can be appreciated that the container 10 may communicate with a user device 76, or a server 68, or both. A server 68 includes a processor 70, memory/database 72 and a communication device 74 capable of communicating with the user device 76, or a third party device 78, or both. Examples of a user device 76 or a third party device 78 include pagers, cellular phones, cellular smart-phones, personal computers, laptops, tablets, handheld wireless communication devices, wirelessly enabled tabled computers, handheld gaming devices, in-vehicle navigation or infotainment systems and the like. In one example, data and information from the container 10 may be sent directly to the user device 76. In another example, the container 10 may send data and information to the server 68, where some or all of the data and information is subsequently sent to the user device 76, or a third party device 78, or both. In yet another example, data and information from the container 10 is sent to both a user device 76 and a server 68, whereby the server 68 subsequently notifies a third party device 78 that information has changed. As such, it is apparent to one skilled in the art that various methods and combinations of methods can be used for communication purposes.

The user device 76 will hereinafter refer to the device used by a user of the container 10. This can include the home owner, business, or any other parties or stakeholders associated with the container 10. The third party device 78 will hereinafter refer to the device used by an entity not directly affiliated with the container 10. This can include the shipping company, the manufacturer, the supplier, the retailer or other parties. It will be appreciated that there may be one or more user devices 76. Similarly, there may be one or more third party devices 78. Furthermore, each of such devices 76, 78, as well as the server 68, include a processor, a memory, a communication device and may further include a display device.

In an example embodiment, the user device 76 is capable of controlling the operations of, and also receiving notifications from the container 10. Instructions are generated from a user device 76 and sent to the container 10, where the instructions are subsequently executed by the controller 56 of the container 10. For example, a user device 76 instructs the container 10 that a delivery is to be expected at 13:00 (e.g. 1:00 PM) and the temperature of the cooling compartment is to be 5° C. The container 10 receives the instructions and the controller 56 executes the necessary operations. Status reports and notifications may be generated and sent from the container 10 to the user device 76. All data may be logged and further accessed via the server 68.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer or processor readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, or module, or both. Any such computer storage media may be part of the container 10, the user device 76, the third party device 78, or the server 68, or accessible or connectable thereto. Any application or module herein described may be implemented using computer or processor readable/executable instructions or operations that may be stored or otherwise held by such computer readable media.

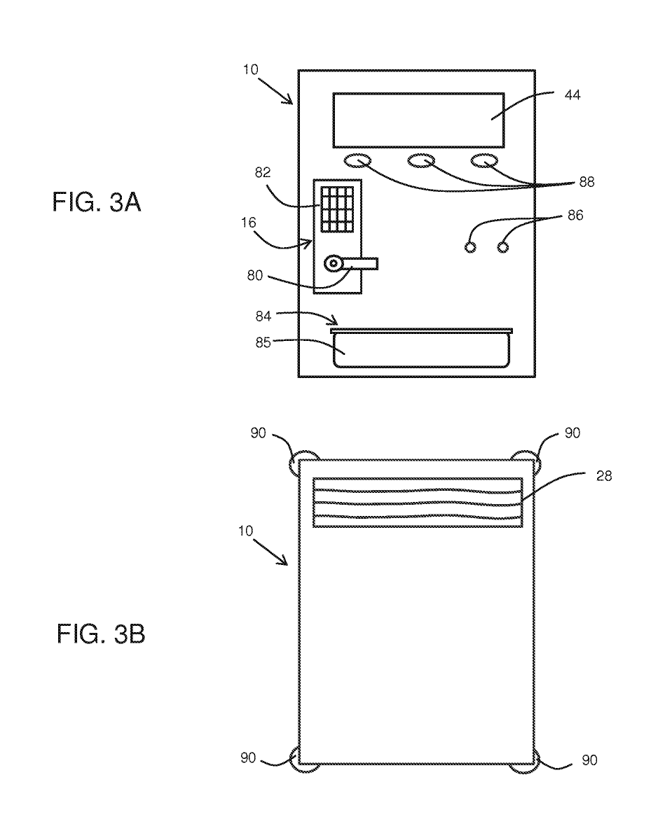

Turning to FIGS. 3A and 3B, shown therein are an example front view and a side profile view of the container 10. In FIG. 3A, the container 10 includes a display device 44, user input devices 48 in the form of buttons 88, light indicators 86, a lock device 16 including a door handle 80 and an alphanumeric keypad 82, and a mailbox 84. The buttons 88 are used to control the operation of the display device 44. The buttons 88 are either physical buttons thereby providing tactile feedback, or virtual buttons. The light indicators 86 may be LED lights capable of, for example, notifying that a delivery has been made or illustrating the current status of the container 10. The keypad 82 of the lock device 16 is configured to receive user inputs, and is used to control the operation of the door. By lifting the door 85 of the mailbox 84, small packages, such as mail, may be inserted therein. The mailbox 84 of FIG. 3A is continuous through the door 24 and is connected to the interior receiving slot 26 of FIG. 1. As such, goods inserted in the mailbox 84 are received by the interior receiving slot 26. The goods are stored in the neutral holding section of the container 10.

A side profile view of the container 10 is shown in FIG. 3B. The vent 28 facilitates the convection of heat generated by electrical components such as the cooling unit 12 and the heating unit 14. The vent 28 is also configured to allow ambient air into the compartments of the container 10. In an example embodiment, if the ambient air temperature is lower than the desired internal temperature of the refrigeration compartment, then the vent 28 opens to allow the flow of cooler ambient air into the refrigeration compartment. In effect, this cools the refrigeration compartment. It can be appreciated that this method decreases energy consumption since the cooling unit is not required to turn on.

Included in the corners of the container 10 shown in FIG. 3B are attachment apparatuses 90 capable of securing the container 10 against a securing surface, such as a wall. Examples of attachment apparatuses 90 include straps firmly anchored in the securing surface that wrap around the storage device, screws or bolts that go through the attachment apparatus 90 into the securing surface, a chain and padlock system solidly mounted on the container 10 and the securing surface, or a frame such as the attachment apparatus 90 that locks into a mounting apparatus on the securing surface. In another example embodiment, the container 10 is welded to the securing surface. In yet another example embodiment, the container 10 is embedded into and thereby becomes an integral component of the securing surface. The attachment apparatus 90 may also be configured to secure the container 10 to the ground, or to an overhanging object. Thus, it can be appreciated that various methods of securing the container 10 to a securing surface can be used.

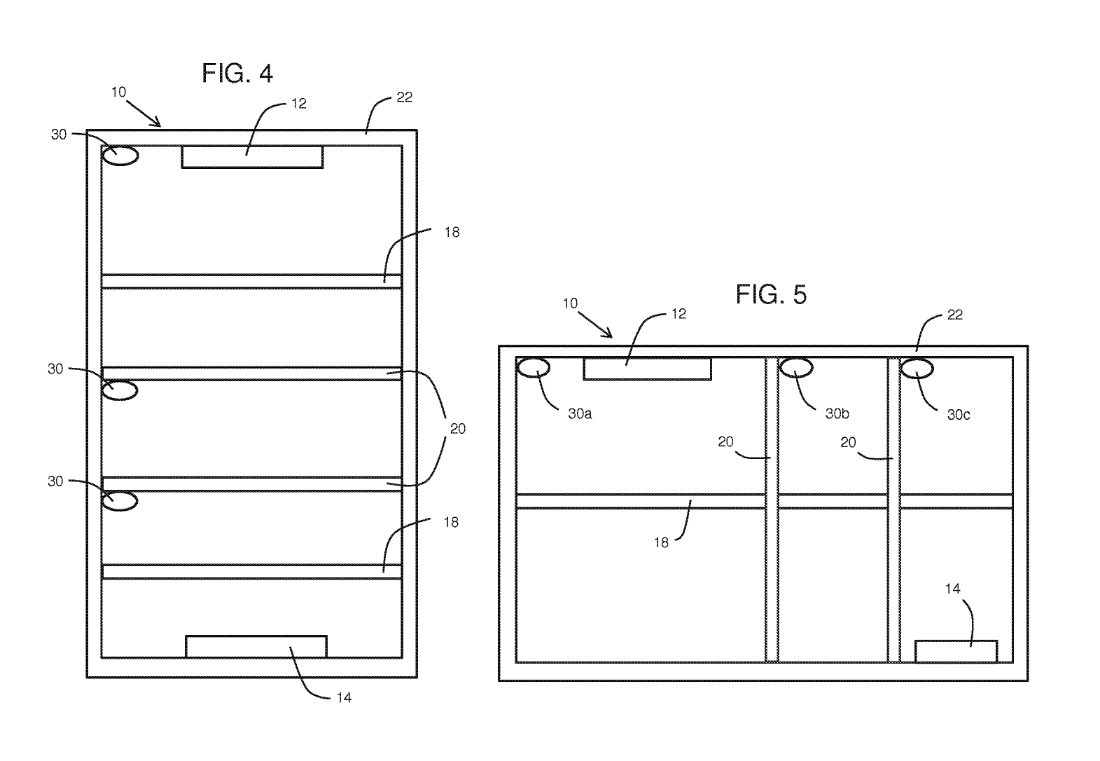

FIG. 4 is an example embodiment of the interior of a container 10 in an upright orientation. As previously described, the supporting frame 22 may include a thermally insulated layer that reduces heat dissipation. A thermally insulated divider 20 may also be used to reduce heat dissipation within the container 10, whereas a non-thermally insulated divider 18 permits heat transfer. It can be appreciated that thermal insulation, and as such the thermally insulated dividers 20, reduces heat dissipation by using specific materials, are provided with mechanisms of reducing heat dissipation, or combinations thereof. Examples of materials that reduce heat dissipation include fibreglass, mineral wool, polyurethane foam, cellulose, polystyrene and combinations of metals or plastics. Examples of mechanisms of reducing heat dissipation include densely packing the material, using insulating seals, or using a coating to reflect heat. It can also be appreciated that non-thermally insulted dividers 18 can be composed of materials that permit heat transfer, are provided with mechanisms of permitting heat transfer, or combinations thereof. For example, the non-thermally insulated dividers can be porous, can be in the form of a grill, can include a hollow slot and a fan for the convection of heat from one section to another, and etc.

Video cameras 30 configured to capture video and take pictures may be mounted inside the container 10. The video cameras 30 may be moved from a first location to a second location to capture multiple videos or pictures, or both, with different views of the interior of the container 10.

A cooling unit 12 capable of cooling a cooling holding section (e.g. top section) of the container 10 is included. In an example embodiment, the cooling unit 12 is in a fixed position. In another example embodiment the cooling unit 12 moves and is not permanently fixed. As such, the cooling unit 12 may be moved to another section of the container 10. Similarly, a heating unit 14 capable of heating a heating holding section (e.g. bottom section) of the container 10 is also included. In one example embodiment, the heating unit 14 is in a fixed position. In another example embodiment, the heating unit 14 moves and is not permanently fixed. It can be appreciated that cooling units 12 and heating units 14 may concurrently and independently heat or cool any one section to ensure the section has reached a desired temperature. It can also be appreciated that the cooling unit 12 and the heating unit 14 may operate in the same section.

FIG. 5 is another example embodiment of the interior of a container 10 in a horizontal orientation. Two thermally insulated dividers 20 partition the container 10 into three vertical sections, and a horizontal non-thermally insulated divider 18 further partitions the vertical sections into sub-compartments. One end section (e.g. left section) includes a cooling unit 12 and a video camera 30a. In this example, the top sub-compartment of the left section is a freezer storage unit, and the bottom sub-compartment is a refrigeration storage unit. The middle section also includes a video camera 30b for monitoring the contents therein. The other end section (e.g. right section) includes a heating unit 14 and a video camera 30c. Similar to FIG. 4, it can be appreciated that a number of non-thermally and thermally insulated dividers 18 and 20 respectively can be used to partition the sections or sub-compartments of the container 10. Furthermore, the dividers may be adjusted to change the shape and size of the sections.

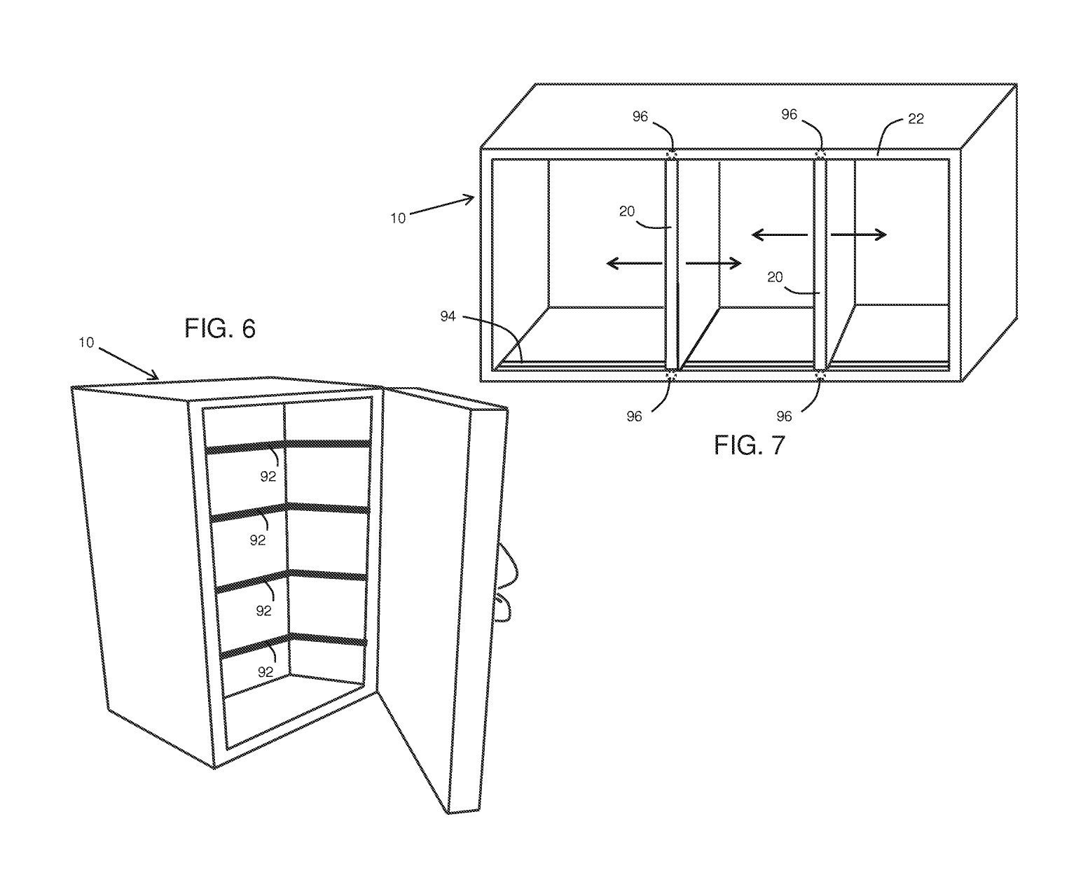

FIG. 6 is a perspective view of the interior of an upright container 10 with the interior shelving or dividers removed. In an example embodiment, the dividers are adjusted by manually ejecting and inserting the divider into one of the divider slots 92. The modularity of this configuration facilitates the replacement of a non-thermally insulated divider with a thermally insulated divider, and vice versa. In FIG. 6, four divider slots 92 oriented horizontally are shown; however it can be appreciated that a number of divider slots in any orientation can be used.

FIG. 7 is a perspective view of the interior of a horizontal container 10 where two thermally insulated dividers 20 are shown. The door, though present, is not shown in FIG. 7 to more clearly show the dividers. In this example embodiment, the size of the sections are adjusted by sliding the thermally insulated divider 20 along a set of guiding rails 94, at least one of which is shown in FIG. 7. As such, the thermally insulated dividers 20 move in various directions as shown by the arrows. The thermally insulated divider 20, for example, is equipped with rolling wheels 96 which facilitate the sliding. In an example embodiment, the rollers wheels 96 are not visible externally and are positioned within the thermally insulated divider 20. It can be appreciated that a non-thermally insulated divider 18 can be used in place of, or in addition to the thermally insulated divider 20. Other mechanisms and configurations used to slide panels or dividers can be used with the container.

FIG. 6 and FIG. 7 illustrate two example embodiments of adjusting the size of the sections by moving the thermally insulating or non-thermally insulating dividers. Those skilled in the art can appreciate that other methods and mechanisms may also be used. Other methods include, but are not limited to, a telescoping guide, foldable struts, hinges or hooks.

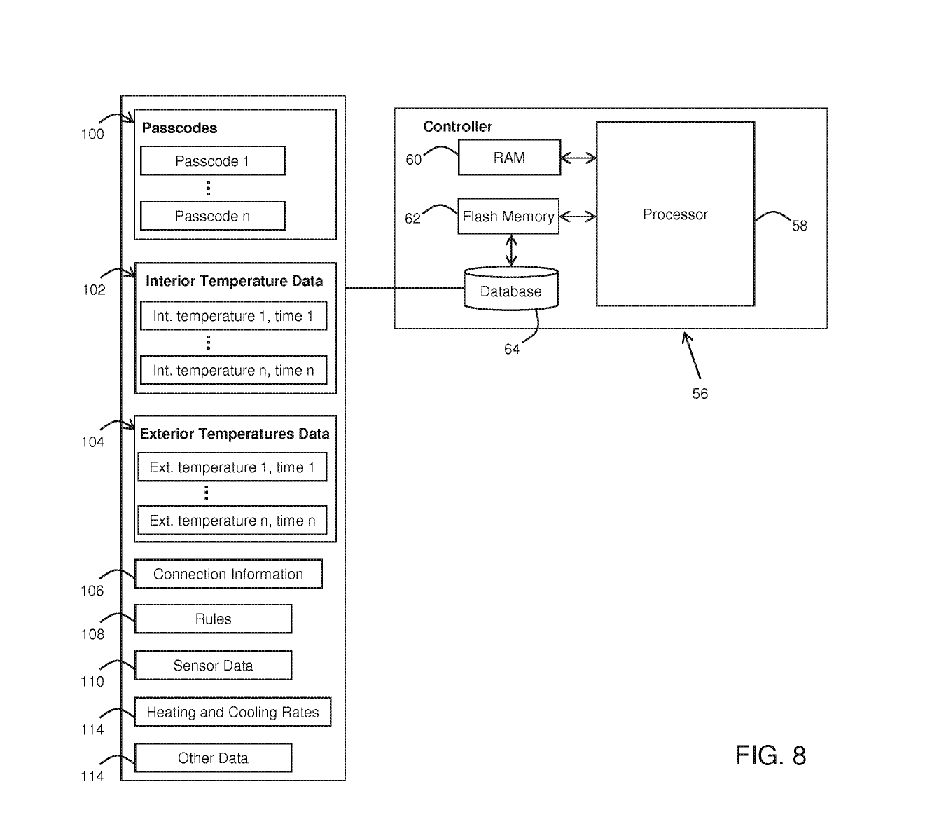

Turning to FIG. 8, the controller 56 of the container 10 includes a processor 58, RAM 60, flash memory 62 and an accompanying database 64. The database 64 is configured to store persistent data. The data includes, for example, passcodes 100, interior temperature data 102, exterior temperature data 104, connection information 106 rules 108, sensor data 110, heating and cooling rates 112 and other data 114.

Passcodes 100 may include all previously used passcodes, the number of times a given passcode has been used, and a company or entity associated with each passcode. For example, the passcode ‘1234’ is assigned to Company X, while the passcode ‘5678’ is assigned to Company Y. The passcodes 100 include one or more active or expired passcodes, or both types, and any associated data.

Interior temperature data 102 may include a history of the interior space 32 temperature along with an associated time stamp. For example, the interior temperature data 102 is stored as interior temperature 1 at time 1, up to interior temperature n at time n. Similarly, the exterior temperature data 104 includes a history of the temperatures exterior to the container 10 with an associated time stamp. For example, the exterior temperature data 104 is stored as exterior temperature 1 at time 1, up to exterior temperature n at time n.

Connection information 106 facilitates automatic connection to a network or a device. The network and device connection information includes, for example, security tokens, the frequency at which a signal is to be transmitted, and device identification information. Other connection information includes the type of connection required (e.g. Bluetooth, Wi-Fi, and GPRS) and other connection data. Rules 108 include user specifications and safety mechanisms. In an example, a rule 108 specifies that the container 10 is not to be opened (e.g. the container is locked) between the times of 23:00 to 4:00. In another example, a rule 108 specifies that the internal temperature of the heating unit compartment should not exceed a certain temperature threshold (e.g. 300° F.). In yet another example, a rule 108 specifies when a notification is to be sent to a user device 76. It can be appreciated that various rules may be stored and used.

Sensor data 110, for example, includes data obtained from one or more sensors 46. This can include pictures taken by the video camera 30, weights detected by the pressure sensor 48, and times at which the door 24 was opened as detected by the door switch 52. Heating and cooling rates 110 include the calculated rates at which the interior temperature can change. For example, the processor 58 analyzes interior temperature data 102 and exterior temperature data 104 to calculate that it will take a certain amount of time to decrease or increase the internal temperature of the refrigeration compartment by a desired number of degrees Fahrenheit (° F.) or Celsius (° C.). Other data 112 may also be stored in the database 64 and may be accessed by the processor 58.

For example, based on the current internal temperature and the desired internal temperature, the processor examines the heating or cooling rate capabilities based on previously collected data. This heating or cooling rate is used to compute how much time is required to obtain the desired internal temperature. The computed time is used to schedule when the temperature regulating device should be turned on prior to an expected delivery time.

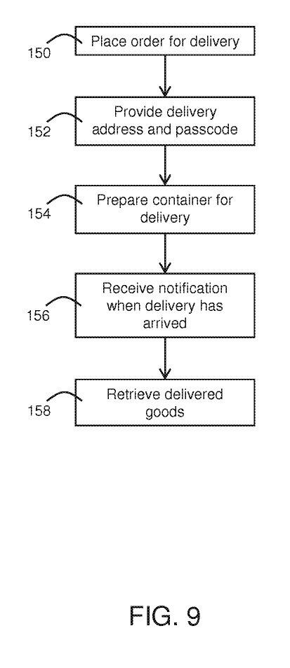

FIG. 9 is an example embodiment of operating the container 10 system. First, an order is placed at 152. The order can be made online, via the internet, by phone, in person, or any other suitable method. During the ordering process or after the order is made, at 152 a delivery address and passcode for the container 10 are provided to the delivery party, if such information has not already been provided beforehand. In an example embodiment, the passcode and delivery address are already known if a prior delivery was made. The container is subsequently prepared for the delivery at 154. Preparations include the controller 56 storing the time period or time at which the delivery is expected and setting a desired temperature for the temperature regulating device 13. After the delivery has arrived, a user device 76 is notified as such at 156, after which the user retrieves the delivered goods at 158.

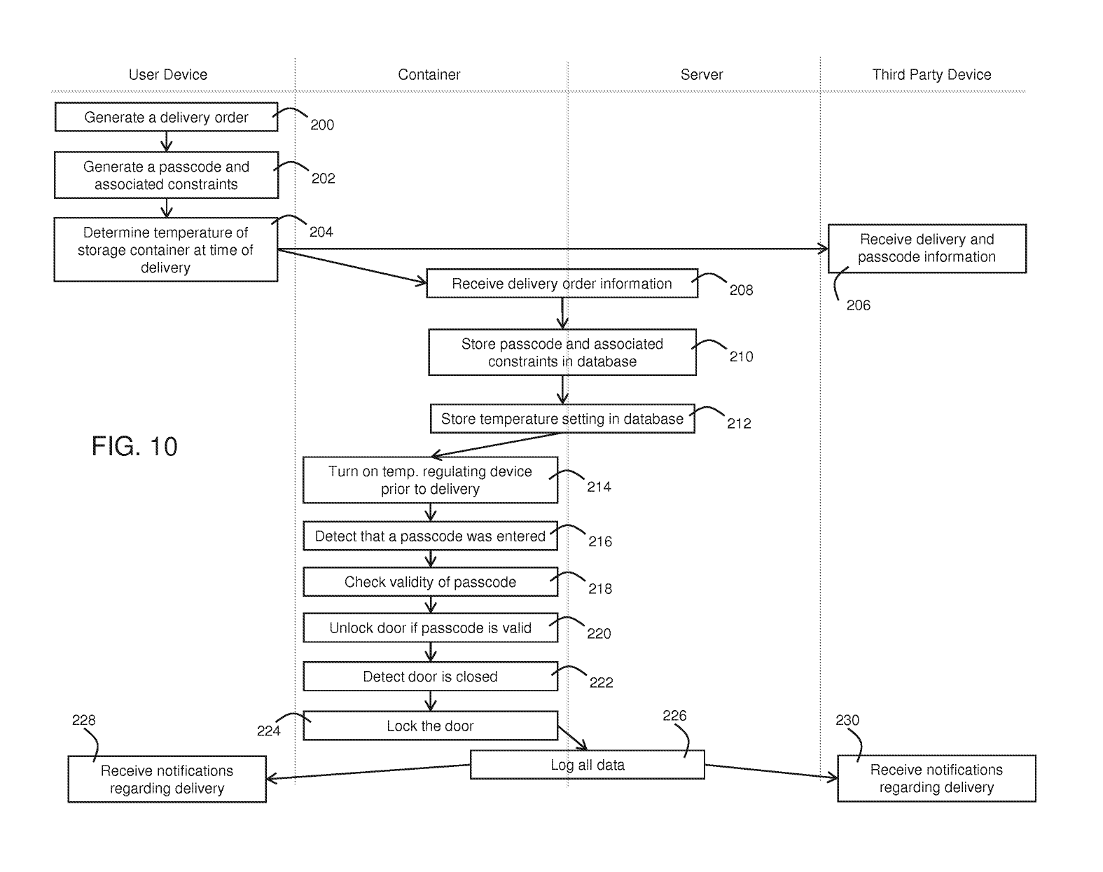

FIG. 10 is an example of instructions that may be executed, generated and received by the user device 76, the container 10, the server 68, and the third party device 78. In this example, the user device 76 generates a delivery order at 200. A passcode and any associated constraints may be included in the delivery order information at 202. In an example embodiment, the constraints include a time constraint whereby the passcode is valid between a specified time period. In another example embodiment, a constraint for the number of uses is included. For example, a constraint dictates that a passcode is permitted for one time use, therefore any second or subsequent entry of the passcode is invalid.

At 204 the desired temperature of the container 10 at the time of the delivery may be included with the delivery order information. As such, the cooling unit 12 or the heating unit 14 is automatically turned on prior to the delivery in order to achieve the desired temperature. The delivery order information along with the passcode, passcode constraints and the desired temperature of the storage container at the time of delivery are sent to one of, or both the container 10 and the server 68 at 208. The third party device 78 may also be configured to receive the delivery order information and passcode information including any associated constraints at 206. Following 208, at 210 the passcode and associated constraints are stored in one of, or both, the databases 64 and 72 of the container 10 and server 68. Similarly, temperature settings information is also stored at 212. The operations of blocks 208, 210, 212 may be performed by the container, or the server, or both. In another example, the container performs some of these operations and the server performs the remaining of these operations.

Prior to the delivery, the temperature regulating device 13 of the container 10 is turned on at 214. The time at which the temperature regulating device 13 is turned on may be determined by the processor 58 of the controller 56 by evaluating historical data, including cooling and heating rate data. For example, the controller 56 determines it will take at least X minutes to change the current internal temperature to a desired temperature. Therefore, the controller 56 turns on the temperature regulating device 13 at least X minutes prior to the expected delivery time.

At 216 the container 10 detects that a passcode was entered. The validity of the passcode is subsequently checked at 218. If the passcode is valid, then the door, such as the door 24, is unlocked at 220. The container 10 detects if the door is closed at 222. After the delivery is completed the door is locked at 224. It can be appreciated that all data is logged on the container, or on the server, or both, at 226. Data logging may include the temperature of the container 10 at a given time, the time at which the door was opened or closed, the entered passcode, and other data obtained from the container 10. At 228 and at 230, the user device 76 and the third party device 78 optionally receive a notification regarding the delivery. The notification, for example, includes a confirmation regarding the successful delivery and noting the time of the delivery.

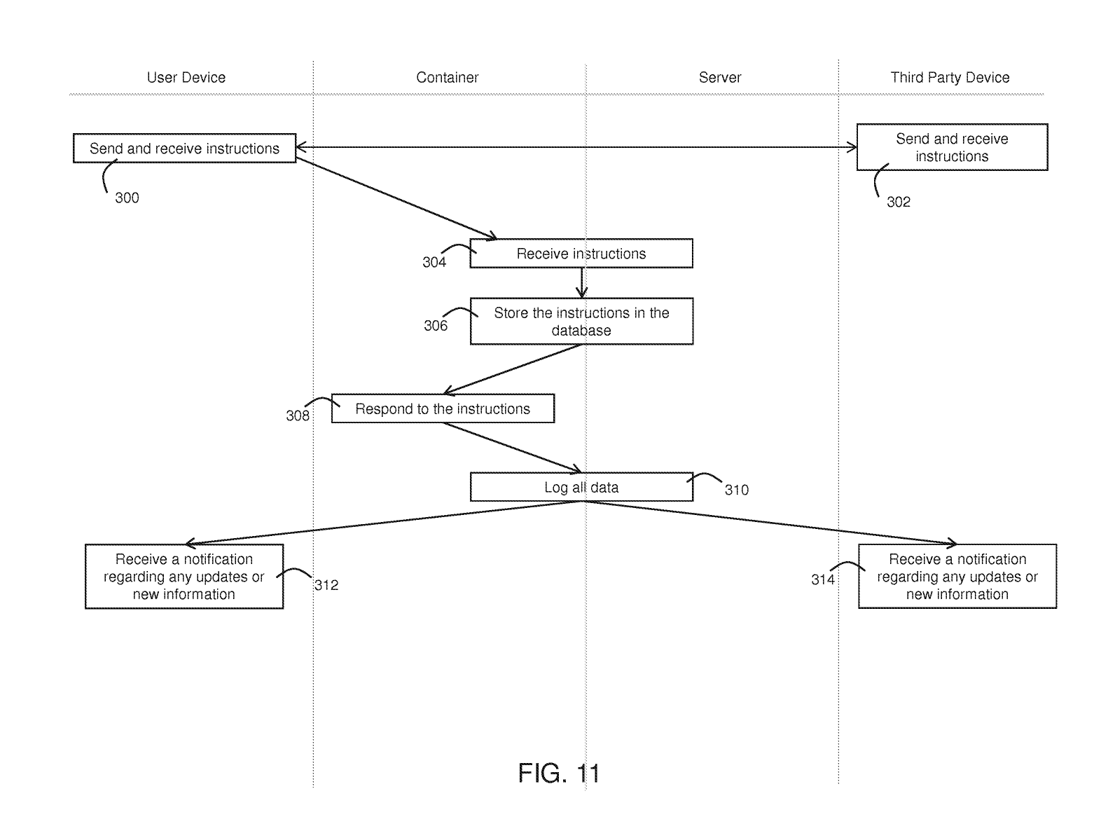

FIG. 11 is another example of instructions that are executed, generated and received by the user device 76, the container 10, the server 68, and the third party device 78. In this example, those skilled in the art can appreciate that instructions are sent and received at any moment by any one of the four devices. At 300 and 302, the user device 76 and the third party device 78 may send and receive instructions amongst each other. In an example embodiment, only the user device 76 is able to communicate with the container 10. In other examples, the server 68 or the third party device 78, or both, communicate with the container 10. In a preferred example, controlling instructions are only sent by the user device 76 to the container 10 in order to protect the container 10 from being controlled by any party other than the user or owner of the container 10. Information, however, may be exchanged between the container 10, and the third party device 78 to facilitate coordination of activities. The container 10 receives the instructions at 304. It is appreciated that blocks shown straddling the container and server columns in FIG. 11 indicate operations are performed by one or both of the container 10 and the server 68. The instructions are stored in the databases of the container 10 and the server 68 at 306. The container 10 responds to the instructions at 308. Similar to FIG. 10, at 310 data is logged by the container 10, or the server 68, or both. At 312 and at 314, the user device 76 and the third party device 78 optionally receive a notification regarding the delivery.

In an example of FIG. 11, the user device 76 instructs the third party device 78 that the passcode is changed to a new passcode. As such, both the third party device 78 and the container 10 receive the updated passcode, after which the new passcode is stored in the database of the container 10, or the server 68, or both. The container 10 sends an acknowledgement of the updated passcode to the user device 76. All changes and actions executed by the container 10 or the server 68 may be logged.

In another example of FIG. 11, the user device 76 instructs the container 10 to change the internal temperature to a new internal temperature. In this example the third party device 78 is not instructed of such a change. The container 10 receives the new temperature instruction, after which the new temperature instruction is stored in the database of the container 10 and the server 68. The container 10 sends an acknowledgement of the new temperature instruction to the user device 76. All changes and actions executed by the container 10, or the server 68, or both, may be logged.

In FIG. 10 and FIG. 11, it can be appreciated that user device 76 instructions and other data may be stored in both the container 10 and the server 68. However, instances may arise where a connection between any two of the devices cannot be established. In one example, the user device 76 is configured to connect over a network to both the server 68 and the container 10. However, neither a connection between the user device 76 and the container 10 nor a connection between the server 68 and the container 10 can be established. As such, instructions generated from the user device 76 are stored on the server 68 but are marked as not received by the container 10. Accordingly, the data is prioritized and will be sent when a connection between the container 10 and at least one of the user device 76 or the server 68 can be established.

Although the blocks illustrated in FIG. 10 and FIG. 11 are shown in sequential order, it can be appreciated that the blocks are not limiting and as such may occur in different orders. Additionally, many computer executable operations may occur simultaneously and are not limited to the example embodiments described herein.

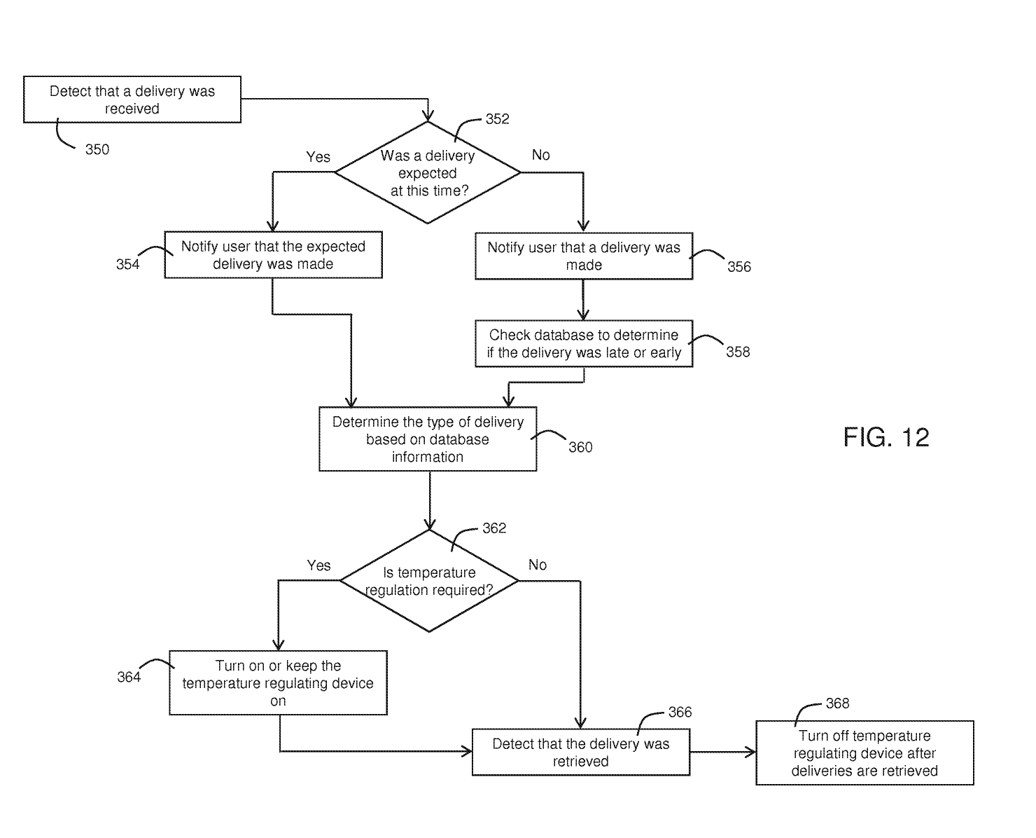

Turning to FIG. 12, a block diagram of example computer executable instructions for determining if temperature regulation is required after a delivery was received is shown. The instructions may be implemented by the container 10. At 350, the container 10 detects that a delivery was received. It can be appreciated that the detection of a delivery may be performed by any one of the sensors 46. In an example embodiment, the container 10 attributes the opening of the door 24 as detected by the door switch 52 as a received delivery. In another example embodiment, the pressure sensors 48 detect that additional weight was added to at least one divider 18 or 20. In yet another example embodiment, image processing algorithms are used on images captured by the video camera 30 to determine if new items were added.

Following 350, a check to determine if a delivery was expected at the current time is made at 352. If a delivery was expected, then the user is notified that an expected delivery was made at 354. If not, then at 356 the user is notified that a delivery was made and the database is subsequently checked to determine if the delivery was late or early at 358. Both 354 and 358 converge at 360, where the type of delivery is determined based on the database information. The type of delivery can include, for example, groceries, clothes, shoes, jewelry, and etc. The type of the object(s) delivered may also be obtained from the delivery order. A check is made at 362 to determine if temperature regulation is required based on the type of object(s) delivered. If temperature regulation is required, then the temperature regulating device 13 is turned on or kept on at 364. If temperature regulation is not required, the temperature regulating device is not turned on. The container 10 waits until the delivery is retrieved at 366 and ensures that the temperature regulating device is turned off after the delivery is retrieved at 368.

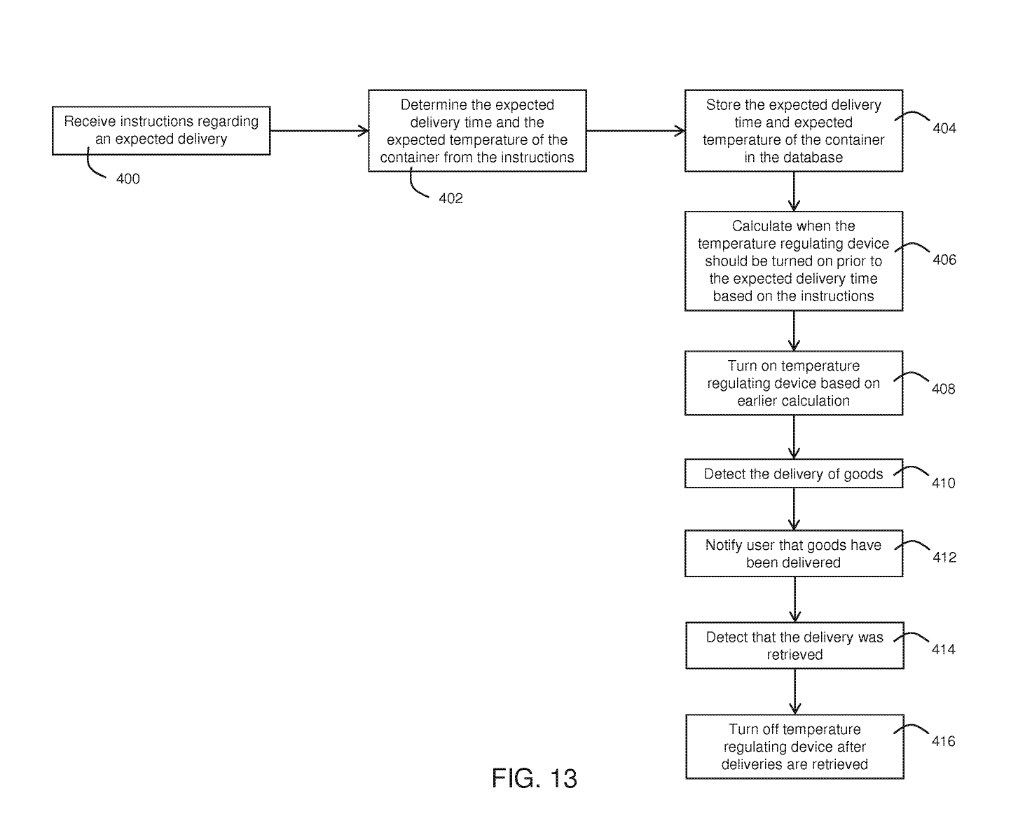

FIG. 13 depicts example processor executable instructions to determine when the temperature regulating device should be turned on or off. At 400 the container 10 receives instructions regarding an expected delivery. At 402 the expected delivery time and the expected temperature of the container are determined from the instructions and subsequently stored in the database of the container 10 at 404. Using the received instructions, the processor 58 of the controller 56 calculates when the temperature regulating device 13 should be turned on prior to the expected delivery time at 406. The temperature regulating device 13 is subsequently turned on at the appropriate time at 408 based on the earlier calculation. At 410 it is detected that goods have been delivered to the container 10. The user via the user device 76 or the display device 44 is notified that goods have been delivered at 412. The container 10 detects that the delivery was retrieved at 414 before ensuring that the temperature regulating device 13 is turned off at 416.

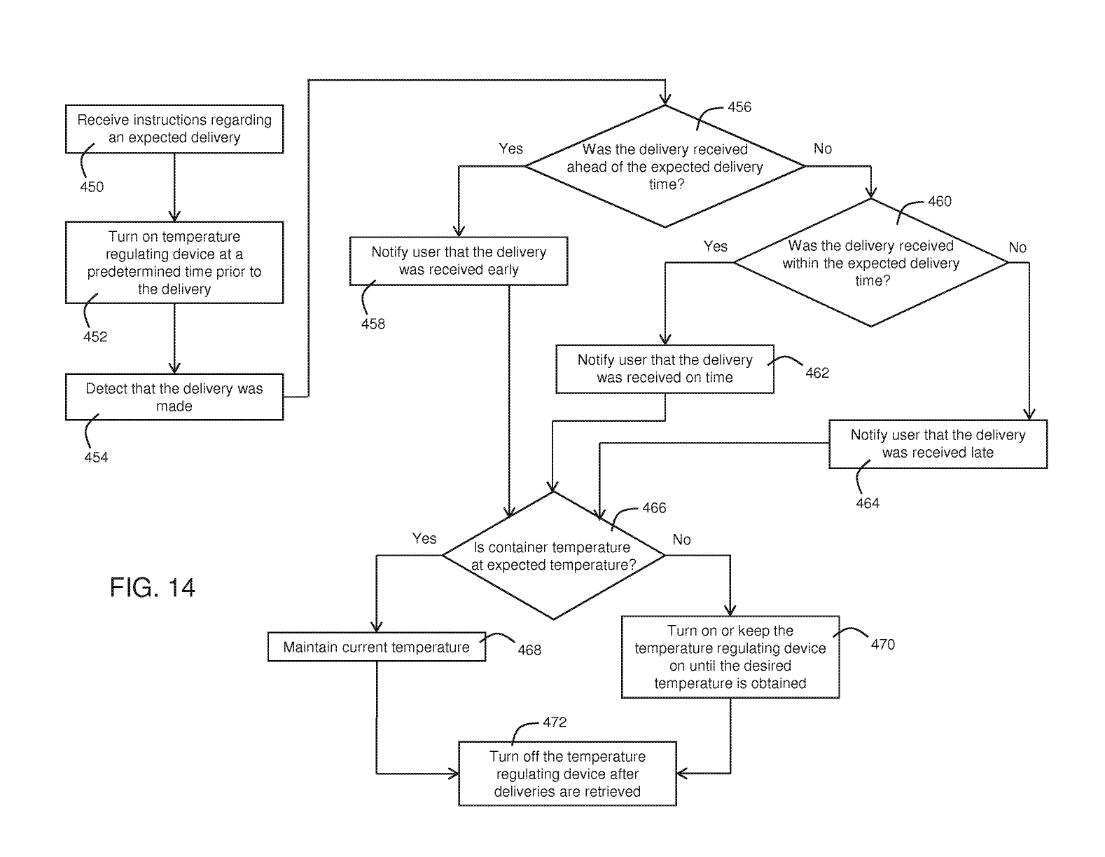

FIG. 14 depicts example processor executable instructions for determining if temperature regulation is required after an expected delivery is received. The container 10 first receives instructions regarding an expected delivery at 450. The temperature regulating device 13 is turned on at a predetermined time prior to the delivery at 452. The predetermined time is calculated based on historical heating or cooling rates, the current internal temperature, the expected delivery time, and optionally the current external temperature. The container 10 then detects that the delivery was received at 452. A check is performed at 456 to determine if the delivery was received ahead of the expected delivery time. If the delivery was received early, then the user is appropriately notified at 458. If the delivery was not received early, a second check is performed at 460 to determine if the delivery was received within the expected delivery time. If the delivery was received on time, then the user is appropriately notified at 462. Otherwise the user is notified that the delivery was received late at 464.

Blocks 458, 462 and 464 merge at 466 where a check is made to determine if the container temperature is at the expected temperature. If the container temperature is at the expected temperature, then the temperature is maintained at 468. If not, the temperature regulating device 13 is turned on or kept on until the desired temperature is obtained at 470. At 472, the temperature regulating device 13 is turned off after the deliveries are retrieved.

In both FIG. 12 and FIG. 14, it can be appreciated that temperature regulation may occur prior to and following the receipt of a delivery. Additionally, a user may specify changes to the interior temperature of the container 10, thereby overriding previous instructions and to temporarily execute the new instructions. For example, previous instructions dictate that the container 10 is to achieve a desired temperature of 40° F. Following the receipt of a delivery, the container 10 receives a new instruction dictating that the internal temperature is to increase to 50° F. The temperature regulating device 13 adjusts the temperature of the container to match the new instructions. The new temperature is maintained until the delivery is retrieved.

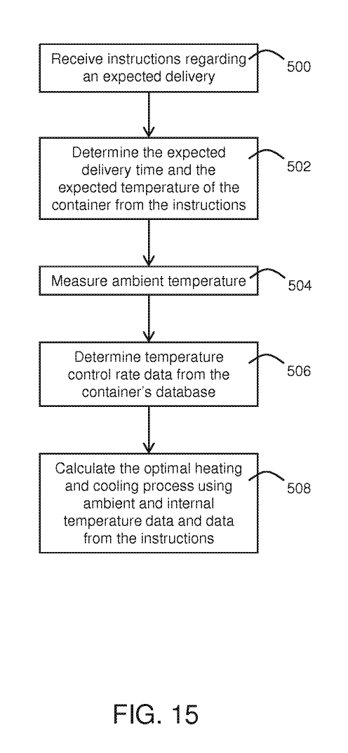

FIG. 15 illustrates examples processor executable instructions for determining an energy efficient heating and cooling process. At 500 the container 10 receives instructions regarding an expected delivery. At 502 the expected delivery time and the expected temperature of the container 10 are determined from the instructions. At 504 an external and an internal thermometer measure the ambient and interior temperature respectively of the container 10. Temperature control rate data is then determined from the database at 506. The temperature control rate data may already exist in the database and may be readily extracted. It can be appreciated that the database may be the container database 64 or the server database 72. The temperature control rate data is the projected rate (e.g. degrees/min) at which the interior of the container 10 can warm or cool. This rate may depend on the temperature regulating device settings and capabilities, the current internal temperature of the container and the current external temperature, among other factors. The relationships between these factors can be determined using data stored in the database 64 and these relationships can be used to compute the temperature control rate.

At 508, ambient and internal temperature data, temperature control rate data and data from the instructions are used to calculate a cooling or heating process. The cooling or heating process determines, for example, whether temperature regulation is required, when the cooling unit 12 or heating unit 12 are to be turned on and whether a vent 28 should be opened. Various machine learning algorithms and other optimization algorithms are used to calculate the cooling or heating process.

It can be appreciated that the machine learning algorithms may account for various factors when determining the cooling and heating process. In addition to the factors described earlier, other factors may include the probability of the deliverer arriving early or late, the expected temperature over the course of the day, and other expected deliveries that may be received. The forecasted external temperature specific to the location of a given container may be automatically obtained, for example, via the Internet from a weather forecasting website.

The cooling or heating process is also configured to record the amount of energy consumed via the container. The energy consumption data is compared with historical energy consumption data to ensure that energy efficiency is achieved.

It can also be appreciated that the desired interior temperature of the container 10 does not need to be achieved at the earliest time of the provided time period. In an example of FIG. 15, the container 10 receives instructions regarding an expected delivery between 15:00 and 18:00 whereby the internal temperature is desired to be 40° F. Since the initial conditions are such that the internal container temperature is 50° F. and the ambient temperature is 70° F., the cooling unit 12 is activated. The cooling process determines that the cooling unit 12 should be activated 20 minutes prior to the earlier time of the time period (e.g. 15:00) to set the internal container temperature to 45° F. The temperature of 45° F. is maintained until the delivery is received, after which the cooling unit is again activated to achieve the desired temperature of 40° F. It can be appreciated that energy savings are realized by this cooling process. In the example given, the container is cooled to a first temperature (45° F.) that is maintained. Since the first temperature is warmer than the desired temperature but cooler than the ambient temperature, less energy consumed to maintain the first temperature compared to the desired temperature. In some instances, it would not be energy efficient to maintain a lower temperature for extended periods of time if goods are not received and no items are placed therein. In the event that the delivery arrives towards the beginning of the time period (e.g. closer to 15:00), the refrigeration unit is already at a cool temperature where the desired temperature may be quickly obtained once the delivery is received.

In another example, the cooling unit 12 is turned on 40 minutes prior to the delivery, whereby the desired temperature of 40° F. will be achieved at 15:00.

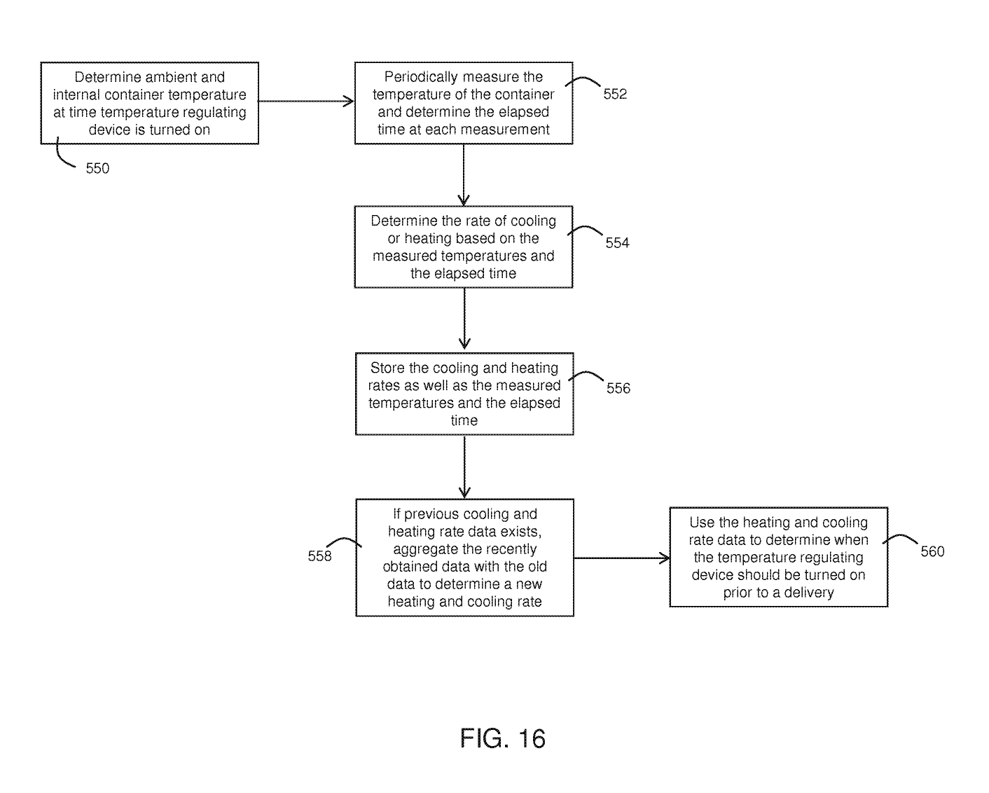

FIG. 16 depicts example processor executable instructions for determining the cooling and heating rate. As previously described, the cooling and heating rate is the estimated speed at which the interior of the container 10 can cool. It can be appreciated that the cooling rate or heating rate is used by the cooling process, or the heating process, or both, to determine when the temperature regulating device 13 should turn on prior to a delivery. At 550, ambient temperature and internal container 10 temperatures are determined at the time the temperature regulating device 13 is to be turned on. The internal temperature of the container 10 is periodically measured and the elapsed time at each measurement is recorded at 552. Using the obtained data, at 554 the rate of cooling or heating is calculated. The rate is represented in units of degrees/minute, degrees/hour, or variants thereof. At 556 the cooling and heating rate data, as well as the measured temperatures and the elapsed time is stored in a database, such as the container database 64, or the server database 72, or both. At 558, if older cooling and heating rate data exists, the data is aggregated with the newly obtained data to determine a new cooling and heating rate. It can be appreciated that the aggregation of the old data with the newly obtained data may be performed by an algorithm capable of weighting received inputs. For example, the newly obtained data can be considered as more important than the old data, and as such the weighting is reflected in the calculation of the new cooling and heating rate. The new cooling and heating rate is used to determine when the temperature regulating device 13 should be turned on prior to a delivery at 560.

It can be appreciated that the storage of data and the calculations may be performed by the container 10, or the server 68, or both. In an example embodiment, the data is stored in the server database 72 and recent data is stored in the container database 64. Similarly, calculations are performed by the server processor 78 and the calculated data is sent to the container 10. In another example embodiment, the data is stored in the container database 64 and recent data is stored in the server database 72. Calculations are performed by the container processor 58 and the calculated data is sent to the server 68. In yet another embodiment, all data is stored in both the server database 72 and the container database 64. Similarly, calculations are performed by both the server processor 70 and the container processor 58, whereby the calculated data is compared to ensure similar results are obtained.

From FIG. 12 to FIG. 16, it can also be appreciated that the temperature regulating device 13 and associated temperature control system may offer power management efficiencies. Traditional cooling or heating units are not equipped with methods capable of determining when the refrigeration or heating compartments should be turned on and off. Energy is wasted when the refrigeration or heating compartments are kept on when few or no items are included therein. Furthermore, users typically must be physically present when turning on or off the refrigeration or heating compartments. The container and associated system described herein addresses such limitations by facilitating integration with other devices, including user devices 76, servers 68 and third party devices 78. When the container 10 is not in use, the container 10 may be turned off remotely via the user device 76. Additionally, temperature regulation is activated automatically and is operative as required. In particular, to improve energy efficiency, temperature regulation is coordinated with the timing of the delivery.

It can also be appreciated that the calculated cooling and heating rates further help improve the container 10 operating conditions. The cooling and heating rates are periodically and automatically calibrated to obtain efficient operating parameters. Ambient air temperature, delivery parameters, temperature profiles and other factors are accounted for when calculating the cooling and heating rates. Thus, less energy is consumed by the cooling and heating units and additional power savings are realized.

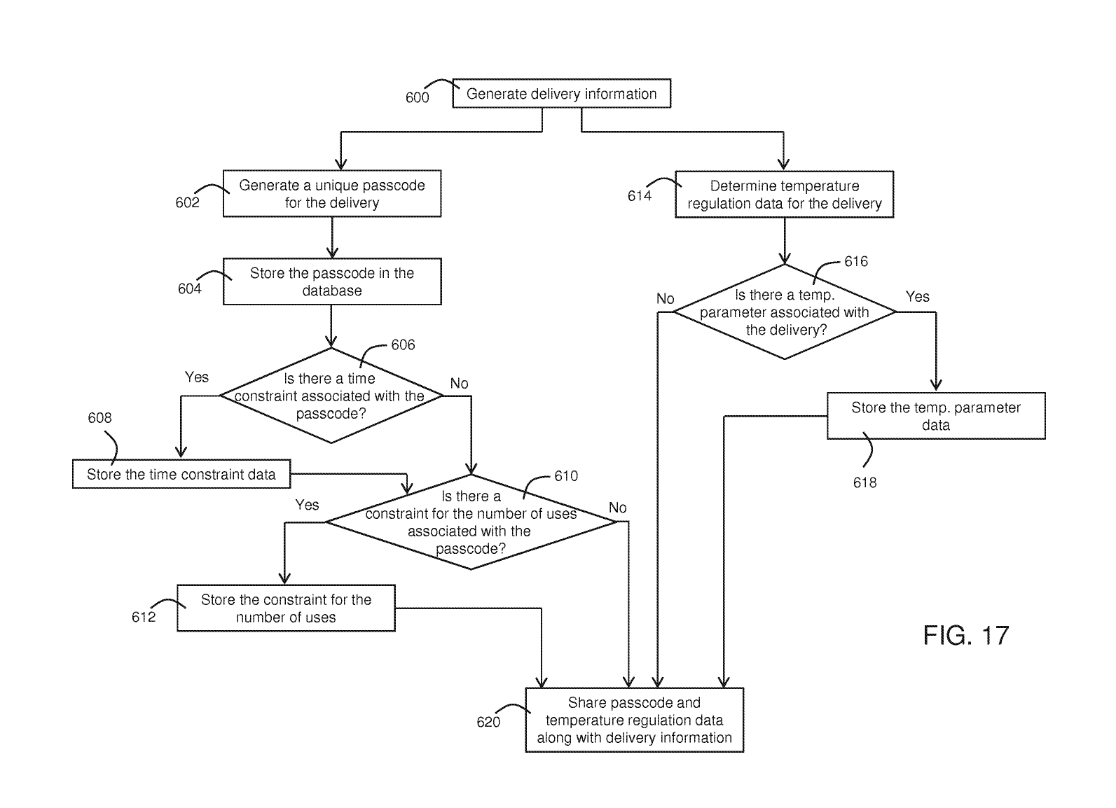

Turning to FIG. 17, example computer or processor executable instructions for generating a passcode and temperature regulation data are shown. It can be appreciated that the passcode may be generated by the user device 76, the container 10 or the server 68. At 600, delivery information is generated and in an example process, at 602 a unique passcode specific for the delivery is generated. In another example, multiple deliveries share a common passcode to unlock the container door 24. The passcode is stored in a database at 604. A check is made at 606 to determine if a time constraint is associated with the passcode. If a time constraint exists, then the time constraint data is stored. For example, a time constraint dictates that the passcode is only valid during the expected delivery time, or during a time period that includes the expected delivery time (e.g. the expected delivery time is 15:00, the time constraint is 14:00 to 16:00). If no time constraint exists or after the time constraint is stored, a check is made at 610 to determine if a constraint for the number of uses of the passcode exists. If yes, then the constraint is stored in the database. If the number of use constraint does not exist, or following the storing of the number of use constraint, the process converges at 620.

In another process, after delivery information is generated at 600, temperature regulation data for the delivery is determined at 614. A check is made at 616 to determine if a temperature parameter is associated with the delivery. Temperature parameter data may include, for example, the desired temperature of the container at the time of the delivery. If yes, the temperature parameter data is stored in the database. If temperature parameter data does not exist, or following the storing of the temperature parameter data, the process converges at 620 where the passcode and temperature regulation data may be shared along with the delivery information. It can be appreciated that processes 602 to 612 may operate independently, concurrently or sequentially with processes 614 to 618. It can also be appreciated that the processes may be executed on any one of a plurality of devices. In one example, processes 602 to 612, whereby a passcode and associated constraints are generated, are executed by the user device 76. In another example, processes 614 to 618, whereby temperature regulation data and associated parameters are determined, are executed by the container 10. The sharing of the passcode and the temperature regulation data may occur following the completion of both processes or after only one process has been completed.

In an example embodiment, only one passcode may be generated. Therefore, additional passcodes cannot be created. The passcode may be associated with the container 10 and shared with at least one deliverer. In another example embodiment, multiple passcodes are generated, whereby each passcode is associated with a time constraint, a number of use constraint and temperature regulation data. The passcodes may be continuously generated and deactivated as required.

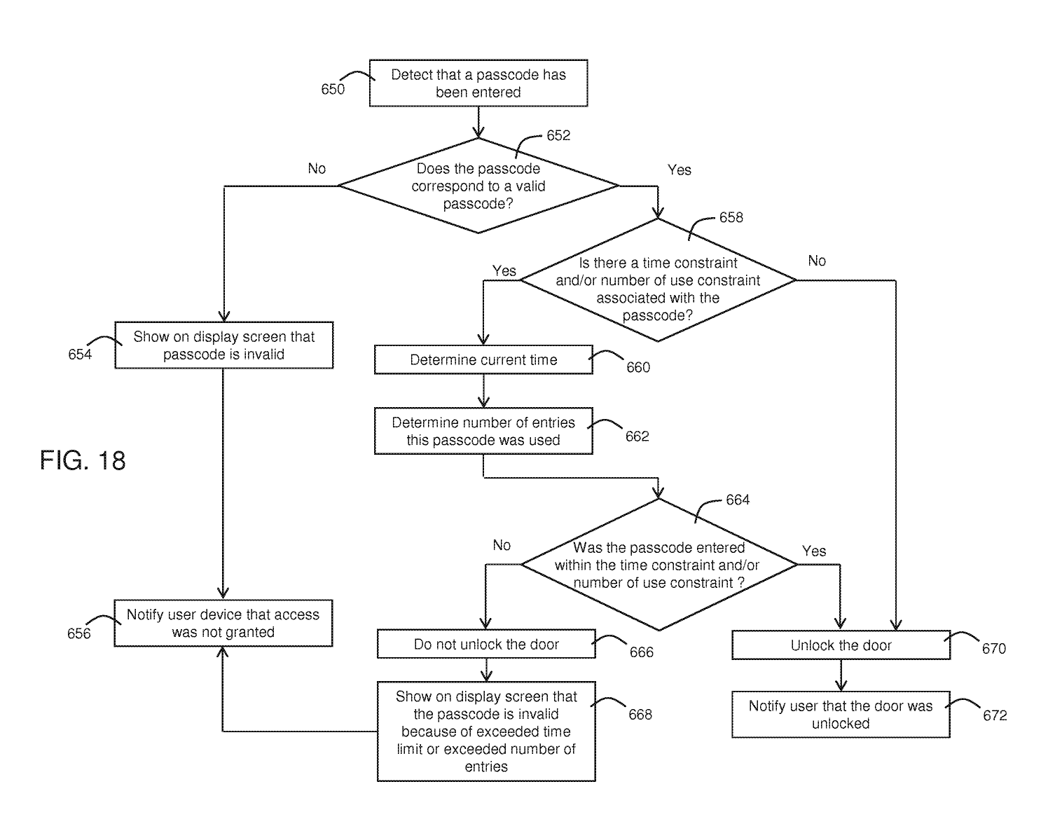

FIG. 18 is a flow diagram of example processor executable instructions for determining the validity of an entered passcode. The container 10 detects that a passcode has been entered at 650. A check is made at 652 to determine if the entered passcode corresponds to a valid passcode. It can be appreciated that all passcodes, including previous passcodes, are stored in the container database 64, or the server database 72, or both, and as such the check at 652 is made against the stored passcodes. If the entered passcode does not correspond to a valid passcode, then at 654 an appropriate message is shown on the display. The user via the user device 76 or the display device 44, or both, may be subsequently notified that access was not granted at 656.

If the entered passcode corresponds to a valid passcode, a second check is made at 658 to determine if a time constraint, or an entry constraint, or both is associated with the passcode. If no constraints are found, the door 24 is unlocked at 670. If constraints are associated with the passcode, at 660 the controller 58 determines the current time as well as the number of entries of the entered passcode at 662. A check is performed at 664 to determine if the passcode was entered within the time constraint, or within the number of use constraint, or both. If yes, the door 24 is unlocked at 670 and the user via the user device 76, or the display device 44, or both, may be notified at 672. If the time constraints were not satisfied, at 666 the door is not unlocked. At 668 the display screen updates to shown that the entered passcode is invalid due to a time limit error, exceeded number of use, or both. The user via the user device 76 or the display device 44, or both, may be subsequently notified that access was not granted at 656.

It can be appreciated that a passcode may be associated with a company, such as a vendor. Thus, once the passcode is entered the controller 56 is able to determine and notify a user that a delivery was received from the corresponding company or vendor. Additionally, at least one of the alphanumeric digits of the entered passcode may specify the type of delivery. For example, as previously described, passcode ‘1234’ corresponds to company X. If an additional alphanumeric character was appended, for example if the passcode reads ‘12341’, then ‘1234’ corresponds to the company whereas the fifth digit ‘1’ specifies the type of object being delivered. Examples of delivery type specifications include groceries, hot food, cold food, shoes, clothes, watch, and etc. The passcode and the delivery type specification may be initialized and subsequently stored in a database when the passcode is created.

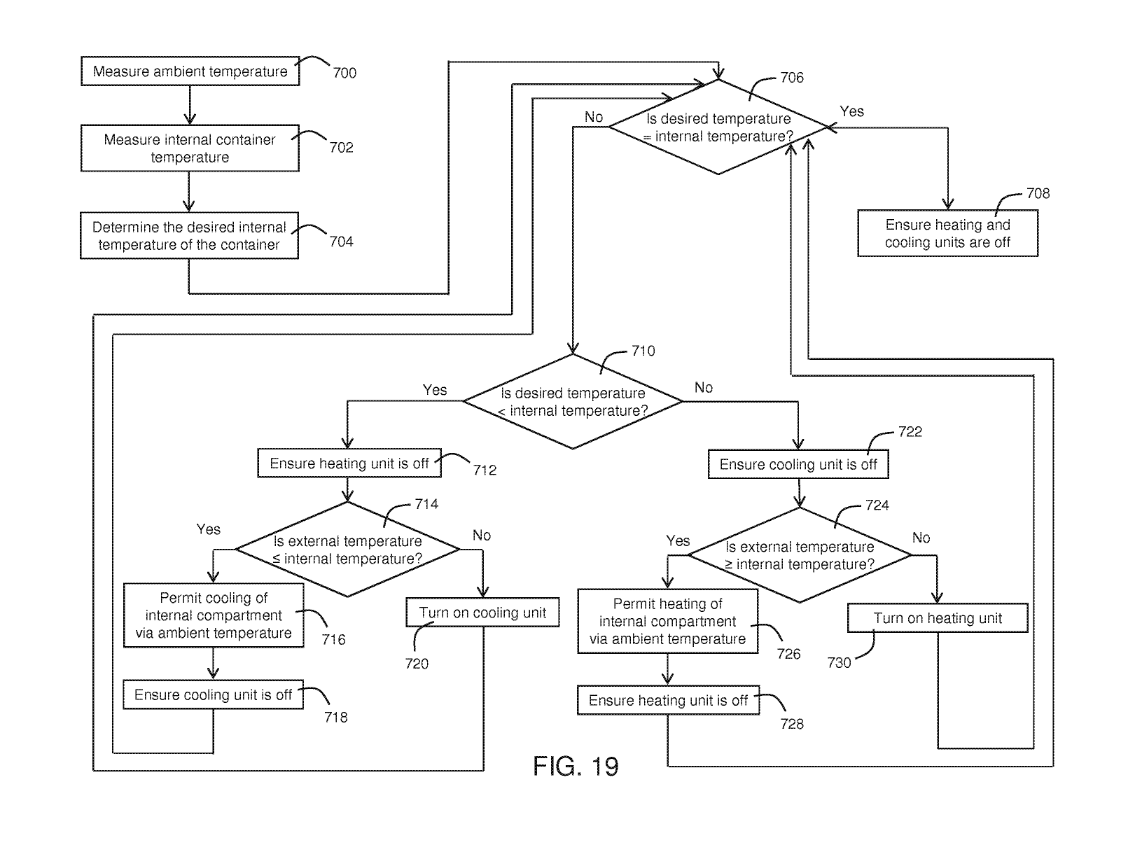

Turning to FIG. 19, example computer executable instructions for determining the internal container 10 temperatures (hereinafter referred to as “internal temperature”) and turning on or off the temperature regulation device is shown. The ambient temperature is first measured at 700 and the internal temperature is subsequently measured at 702. The processor 58 then determines the desired internal temperature at 704, either by pulling temperature data from the database 64 or from new instructions. A check is made at 706 to determine if the desired temperature is equal to the internal temperature. If the temperatures are the same, then the cooling and heating units 12 and 14 respectively are turned off before the process returns to 706. If the temperatures are not consistent, then a second check to determine if the desired temperature is less than the internal temperature is made at 710. If yes, the heating unit 14 is turned off at 712. If the external temperature is less than or equal to the internal temperature at 714, the internal compartment can be cooled via the ambient air at 716 and the cooling unit 12 is turned off at 718. Otherwise, the cooling unit 12 is turned on at 720. The process returns to 706 and repeats.

If the desired temperature was not less than the internal temperature at 710, the cooling unit 12 is turned off at 722. If the external temperature is greater than or equal to the internal temperature, the internal compartment is heated via the ambient air at 726 and the heating unit 14 is turned off at 728. Otherwise, the heating unit 14 is turned on at 730. The process returns to 706 and repeats.

The cooling of the internal compartment via ambient air is achieved by opening a vent, such as the vent 28 shown in FIG. 1 and FIG. 3B. In an example embodiment, the vent 28 facilitates the flow of air into or away from the interior of the container 10. In another example embodiment, the vent 28 is coupled to a fan and includes a ventilation unit for the convection of air into or away from the container 10.

It can be appreciated that FIG. 19 is an example to determine if cooling units 12 and heating units 14 are required to achieve a desired temperature. A control loop feedback mechanism, such as a proportional-integral-derivative controller (“PID controller”) can be used to control the temperature regulating device 13. The PID temperature controller determines and continually adjusts the operation of the cooling unit 12 and the heating unit 14. The proportional controller may set the operation of the temperature regulating device 13 by factoring present error (i.e. the difference between the current temperature and the desired temperature), whereas the integral controller uses past data to determine if the temperature regulating device 13 is set to too high or too low, and the derivative controller predicts future error and may adjust the temperature regulating device accordingly. As such, the PID temperature controller improves the operation of the temperature regulating device by controlling the cooling unit 12 heating unit 14.

In an example embodiment, a single cooling unit 12 and a single heating unit 14 are configured to operate on at least two different thermally insulated sections. As such, only one of cooling or heating may occur in the section. In another example embodiment, multiple cooling units 12 or heating units 14, or multiples of both, are configured to operate on at least two different sections. As such, both cooling and heating may occur in the same section. In yet another embodiment, a cooling unit 12 and a heating unit 14 are not fixed and are therefore capable of moving throughout the container 10. As such, a holding section may be cooled, heated, or both.

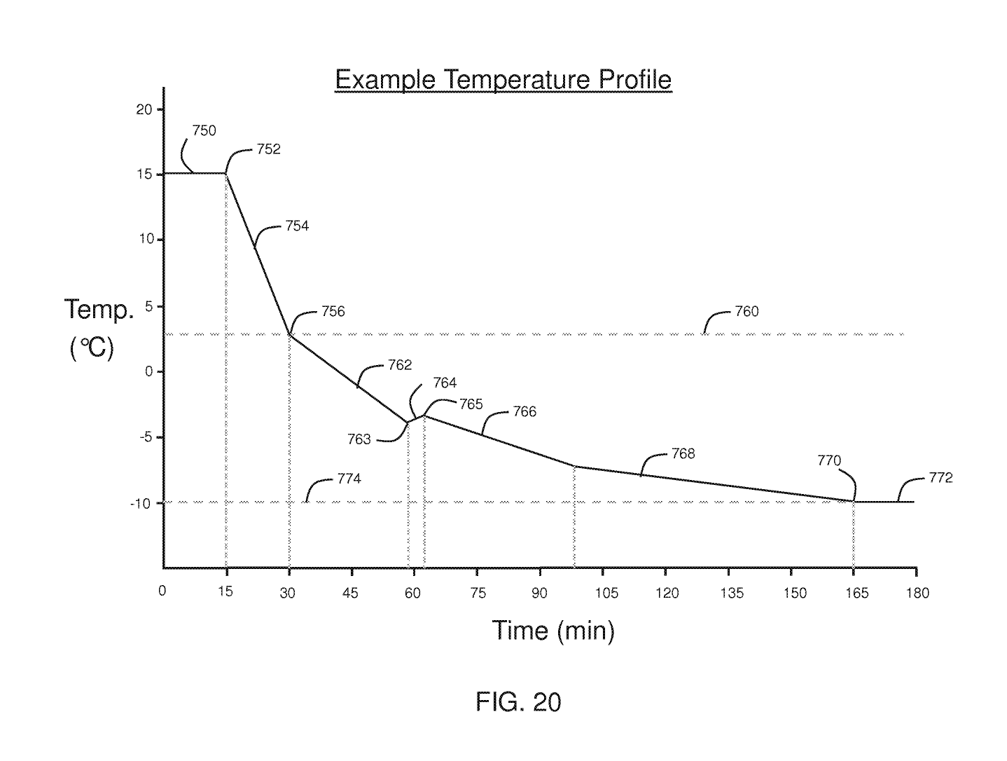

FIG. 20 is an example graph of the internal temperature over time in response to a received instruction. The top horizontal dotted line 760 corresponds to the ambient air temperature and the bottom horizontal dotted line 774 corresponds to the desired internal temperature. In this example, it is known that internal temperature is to decrease to −10° C. in 180 minutes. As such, a cooling process is calculated using cooling rates amongst other obtained data. At time 0 the internal temperature is found to be 15° C., and over the course of 15 minutes the temperature remains constant. Since the ambient air temperature 760 is 3° C. and therefore lower than the internal temperature, at inflection 752 the vents 28 are opened to facilitate an inflow of ambient air. As such, the interior temperature cools with the line 754. After approximately 15 additional minutes, the interior temperature is consistent with the ambient temperature. At 756 the vents 28 are closed and the cooling unit 12 is activated. The interior temperature decreases with line 762 until 763 where the door 24 is opened. It can be appreciated that the door may have opened because a home owner retrieved an item, an unexpected delivery arrived, a home owner inserted an item that must be temperature regulated, or various other reasons. Since the ambient air temperature is greater than the current interior temperature, cool air escapes and the internal temperature slightly increases with line 764. After approximately five minutes the door is closed at 765.

A new cooling rate whereby the internal temperature decreases slower than 762 is used at 766. Similarly another cooling rate is used at 768. It can be appreciated that different cooling rates exist due to faster or slower than expected changes in temperature, the limiting nature of cooling whereby a plateau is reached, or the recalibration of the cooling process and associated cooling rates to ensure that energy efficiency is achieved. After 165 minutes, or 15 minutes prior to the earliest expected delivery time, at 770 the desired temperature of −10° C. is reached. As such, the temperature is maintained and remains constant, as shown by 772.

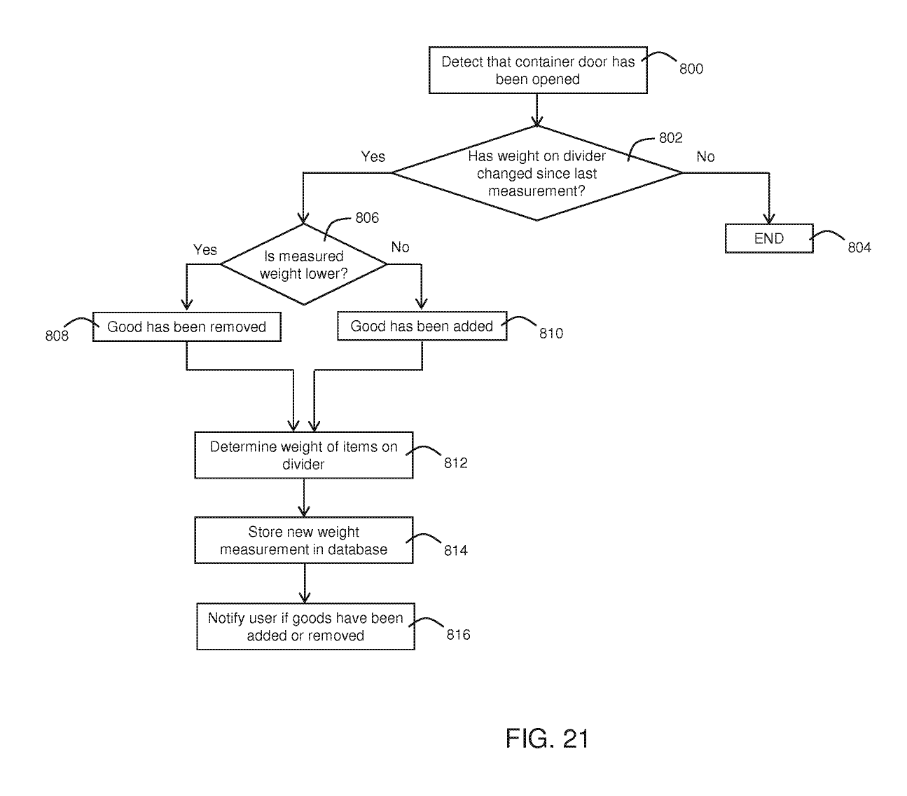

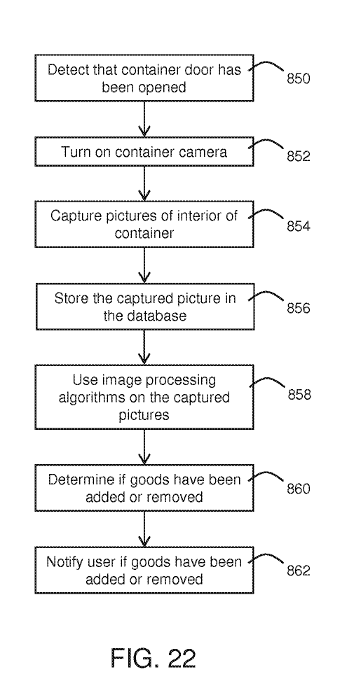

Turning to FIG. 21 and FIG. 22, two methods for determining if goods have been delivered are shown. It can be appreciated that any number of additional systems and methods can be used, including a door switch 52 capable of sensing the opening and closing of the door 24, a RFID reader and accompanying system for recording the insertion or extraction of goods, or manual input indicating that goods have been received.

FIG. 21 is an example of processor executable instructions for determining if the weight on a divider 18 or 20 has changed. The weight may be determined by a pressure sensor 48 that is embedded within the dividers 18 or 20. At 800, it may be optionally detected if the container door 24 has been opened. A check is made at 802 to determine if the weight on the divider has changed since the last weight measurement. If the weight did not change the process ends at 804 and as such no goods were added or removed. If the weight changed, a second check is made at 806 to determine if the measured weight is lower. If yes then it is determined that at least one good has been removed at 808. Otherwise, at 810 at least one good has been added. The new weight of the items is determined at 812 and the weight measurement is stored in the database at 814. The user via the user device 76 or the display device 44, or both, may be notified that goods have been added or removed at 816.

FIG. 22 is an example of processor executable instructions for determining if goods have been delivered by analyzing pictures taken by a camera, such as the video camera 30. At 850 it is optionally detected if the container door 24 has been opened. The camera is turned on at 852 and pictures of the container 10 interior are captured at 854. The pictures are stored in a database at 856, such as the container database 64, or the server database 72, or both. Image processing algorithms, more specifically feature detection, are used on the pictures at 858. The image processing algorithms compare a new picture with an older picture, such as a picture captured before a delivery was made, to determine if goods have been added or removed at 860. The user via the user device 76 or the display device 44, or both, may be notified that goods have been added or removed at 862.

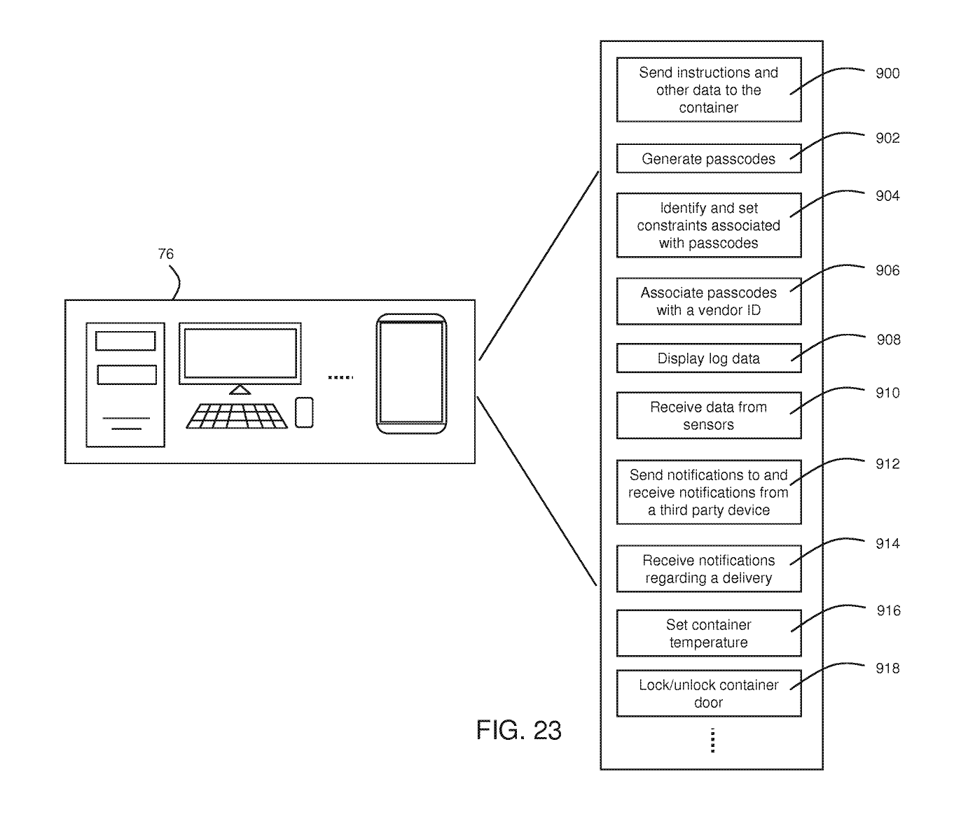

Turning to FIG. 23, shown therein is a block diagram of example computer executable instructions that may be performed by a user device 76. It can be appreciated that a third party device 78 may also execute some if not all of the example computer executable instructions. The user device 76 is configured to send instructions and other data 900 to the container. The instructions include commands, expected delivery times, the expected temperature of the container at the time of delivery, or updates. The user device 76 is configured to generate passcodes 902 and identify and set constraints associated with the passcodes 904. Furthermore, the passcodes may be associated with a company or a vendor's identification 906. Log data is displayed 908 on the display of the user device 76. The log data includes data received from sensors 910, such as the sensors 30. The user device 76 is configured to send notifications to and receive notifications from a third party device 912, such as the third party device 78. Notifications regarding a delivery 914 are also received. The user device 76 is capable of remotely setting container temperature 916 and to lock or unlock the container door 918 at a given moment. It can be seen that the user device 76 controls the overall operations of the container. Those skilled in the art can appreciate that the examples provided herein are not restrictive and as such any number of other instructions and other data may be sent from or received by the user device 76.

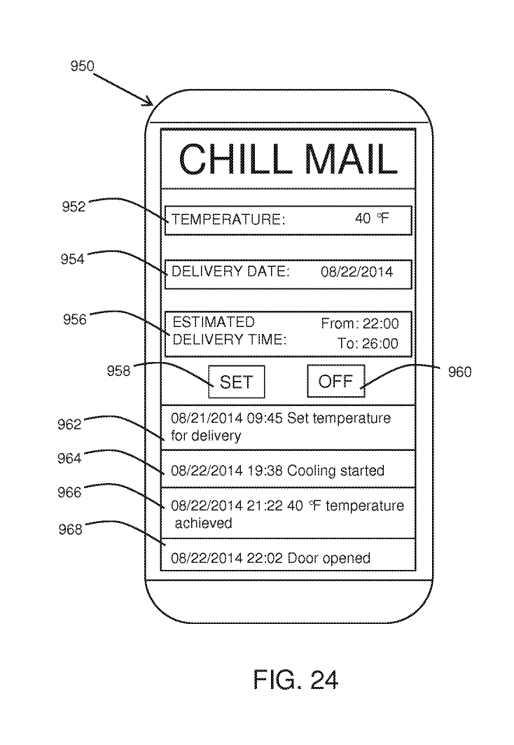

FIG. 24 is an example of the main screen of a user device 76. In this example embodiment the user device 76 is a mobile device 950 where delivery data may be inputted and subsequently sent to a container. The mobile device 950 is capable of setting the current temperature of the container 952, setting the estimated delivery date of the next delivery 954, and setting the estimated delivery time 956 of the next delivery. Instructions are sent to a container by pressing the ‘SET’ button 958. The container is turned off by pressing the ‘OFF’ button 960. The main screen of the mobile device 950 displays log data 962 to 968. In this example, the log data includes setting the temperature for a delivery 962, cooling started 964, set temperature was achieved 966 and container door opened 968. It can be appreciated that other data, in addition to the data shown in the examples, may also be captured and presented in a log.

Below are general example embodiments.

In a general example embodiment, a container is provided for receiving and storing an object. The container comprises: a body defining an interior space for receiving the object; a door for accessing the interior space; a lock device for unlocking and locking the door; a temperature regulating device for regulating the temperature of the interior space; a sensor to indirectly or directly detect whether the object has been placed in the container; memory; and a processor. The processor is configured to cause the container to at least: receive an expected delivery time of the object; and at a predetermined time period before the expected delivery time, regulate the temperature of the interior space.

In an example aspect, the processor is further configured to at least: detect, using the sensor, the object being placed in the interior space; continue regulating the temperature of the interior space; detect, using the sensor, the object being removed from the interior space; and deactivate the temperature regulating device.

In another example aspect, the sensor sends output to the processor, the sensor comprising at least one of: a video camera capable of capturing pictures or video; a door switch capable of notifying the processor that the door has been opened or closed; a pressure sensor to detect the weight of the object; a thermometer to determine the temperature of the interior space; and an RFID reader capable of determining if the object is within the interior space.

In another example aspect, the temperature regulating device comprises at least one of a cooling unit to cool the interior space and a heating unit to heat the interior space.

In another example aspect, the container further comprises a communication device capable of exchanging data with an electronic device and a server.

In another example aspect, the memory is configured to store delivery information, the delivery information comprising: a passcode to unlock the door; a type of the object being delivered; and a temperature of the storage container at the expected delivery time of the object.

In another example aspect, the delivery information further comprises: a time constraint associated with the passcode, wherein the time constraint prevents the unlocking of the door if the passcode is not entered within the time constraint; and a constraint for the number of uses of the passcode, wherein the number of uses constraint prevents the unlocking of the door if the passcode is not entered within the number of use constraint.

In another example aspect, the container further comprises a thermally insulated divider, wherein the divider is configured to be moved from a first position to a second position within the interior space.

In another example aspect, the lock device comprises a receiving device to receive a passcode, the passcode capable of unlocking the door when: the passcode corresponds to a valid passcode; the passcode was entered within a predetermined time constraint; and a number of detected entries of the passcode is less than a predetermined number of entries.

In another example aspect, the processor calculates at least one of a cooling rate and a heating rate, the calculation comprising: determining the temperature of the interior space when the temperature regulating device is turned on; periodically measuring the temperature of the interior space of the container and determining an elapsed time between the periodic measurements; determining a first cooling rate or a first heating rate using the periodic measurements and the elapsed time; and aggregating the first cooling rate or the first heating rate with an older cooling rate or an older heating rate to obtain the cooling rate or the heating rate.

In another example aspect, the processor selects a temperature regulating process prior to the expected delivery of the object, the selection comprising: determining an expected delivery temperature; measuring ambient temperature; determining temperature control rate data; determining an expected energy consumption for a first temperature regulating process by factoring the temperature control rate data with the delivery information, the expected delivery time, the expected delivery temperature and the ambient temperature; calculating an other expected energy consumption of an other temperature regulating process; and selecting the first temperature regulating process when the expected energy consumption is less than the other expected energy consumption.

In another example general embodiment, a container is provided for receiving and storing an object. The container comprises: a body defining an interior space for receiving an object; a door for accessing the interior space; a lock device for unlocking and locking the door; a temperature regulating device for regulating the temperature of the interior space; a sensor to indirectly or directly detect whether the object has been placed in the container; memory; anda processor. The processor is configured to cause the container to at least: detect, using the sensor, the object being placed in the interior space; regulate the temperature of the interior space; detect, using the sensor, the object being removed from the interior space; and deactivate the temperature regulating device.

In an example aspect, the processor is further configured to: determine if the object is received ahead of or before an expected delivery time; and turn on or turn off the temperature regulating device if the object is received ahead of or before an expected delivery time.

In another example aspect, the sensor sends output to the processor, the sensor comprising at least one of: a video camera capable of capturing pictures or video; a door switch capable of notifying the processor that the door has been opened or closed; a pressure sensor to detect the weight of the object; a thermometer to determine the temperature of the interior space or ambient temperature; and an RFID reader capable of determining if the object is within the interior space.

In another example aspect, the temperature regulating device comprises at least one of a cooling unit to cool the interior space and a heating unit to heat the interior space.

In another example aspect, the container further comprises a communication device capable of exchanging data with an electronic device and a server.

In another example aspect, the container further comprises a thermally insulated divider, wherein the divider is configured to be moved from a first position to a second position within the interior space.

In another example aspect, the lock device comprises a receiving device to receive a passcode, the passcode capable of unlocking the door when: the passcode corresponds to a valid passcode; the passcode was entered within a predetermined time constraint; and a number of detected entries of the passcode is less than a predetermined number of entries.

In another example aspect, the processor calculates at least one of a cooling rate and a heating rate, the calculation comprising: determining the temperature of the interior space when the temperature regulating device is turned on; periodically measuring the temperature of the interior space of the container and determining an elapsed time between the periodic measurements; determining a first cooling rate or a first heating rate using the periodic measurements and the elapsed time; and aggregating the first cooling rate or the first heating rate with an older cooling rate or an older heating rate to obtain the cooling rate or the heating rate.

In another example aspect, the processor selects a temperature regulating process after the object is received, the selection comprising: determining an expected delivery temperature; measuring ambient temperature; determining temperature control rate data; determining an expected energy consumption for a first temperature regulating process by factoring the temperature control rate data with the delivery information, the expected delivery time, the expected delivery temperature and the ambient temperature; calculating an other expected energy consumption of an other temperature regulating process; and selecting the first temperature regulating process when the expected energy consumption is less than the other expected energy consumption.

In another example general embodiment, a mobile device is provided for coordinating operation of a container with an expected delivery. The mobile device includes a display, a processor, and a communication device. The mobile device sends data to the container. The data includes an expected time of the expected delivery and temperature information configured to be used by the container for controlling temperature within the container. The mobile device configured to receive data generated from the container, including at least one of a time when the expected delivery to the container occurred and a current temperature within the container.

In an example aspect, the data sent to the container further includes a passcode associated with the expected delivery, the passcode configured to be used by the container to determine whether a door of the container should be locked or unlocked.

In another example aspect, the mobile device communicates with a third party device to establish the expected time of the delivery and thereafter automatically sends the data to the container.

In another example general example embodiment, a server is provided for coordinating interaction between a container and a mobile device. The server includes memory, a processor, and a communication device for communicating with the container and the mobile device. The server receives data from the mobile device, and the data includes an expected time of an expected delivery and temperature information configured to be used by the container for controlling temperature within the container. The server sends the data to the container. The server receives data generated from the container, including at least one of a time when the expected delivery to the container actually occurred and a current temperature within the container.

In an example aspect, the server provides a graphical user interface that may be accessed through Internet and is configured to be displayed on the mobile device. The graphical user interface includes controls to at least one of: set temperature for the container, turn-off a temperature regulating device of the container, and set a passcode used to unlock the container.

The schematics and block diagrams used herein are just for example. Different configurations and names of components can be used. For instance, components and modules can be added, deleted, modified or arranged with differing connections.

The steps or operations in the flow charts and diagrams described herein are just for example. There may be many variations to these steps or operations. For instance, the steps may be performed in a differing order, or steps may be added, deleted or modified.

It will be appreciated that the particular example embodiments shown in the figures and described above are for illustrative purposes only and many other variations can be used according to the principles described. Although the above has been described with reference to certain specific embodiments, various modifications thereof will be apparent to those skilled in the art as outlined in the appended claims.

1. A container for receiving and storing an object, the container comprising:
a body defining an interior space for receiving the object;
a door for accessing the interior space;
a lock device for unlocking and locking the door;
a temperature regulating device for regulating the temperature of the interior space;
a sensor to indirectly or directly detect whether the object has been placed in the container;
memory; and
a processor configured to cause the container to at least:
receive an expected delivery time of the object; and
at a predetermined time period before the expected delivery time, regulate the temperature of the interior space.

2. The container of claim 1, wherein the processor is further configured to at least:
detect, using the sensor, the object being placed in the interior space;
continue regulating the temperature of the interior space;
detect, using the sensor, the object being removed from the interior space; and
deactivate the temperature regulating device.

3. The container of claim 1, wherein the sensor sends output to the processor, the sensor comprising at least one of:
a video camera capable of capturing pictures or video;
a door switch capable of notifying the processor that the door has been opened or closed;
a pressure sensor to detect the weight of the object;
a thermometer to determine the temperature of the interior space; and
an RFID reader capable of determining if the object is within the interior space.

4. The container of claim 1, wherein the temperature regulating device comprises at least one of a cooling unit to cool the interior space and a heating unit to heat the interior space.

5. The container of claim 1, wherein the container further comprises a communication device capable of exchanging data with an electronic device and a server.

6. The container of claim 1, wherein the memory is configured to store delivery information, the delivery information comprising:
a passcode to unlock the door;
a type of the object being delivered; and
a temperature of the storage container at the expected delivery time of the object.

7. The delivery information of claim 6 further comprising:
a time constraint associated with the passcode, wherein the time constraint prevents the unlocking of the door if the passcode is not entered within the time constraint; and
a constraint for the number of uses of the passcode, wherein the number of uses constraint prevents the unlocking of the door if the passcode is not entered within the number of use constraint.

8. The container of claim 1 further comprising a thermally insulated divider, wherein the divider is configured to be moved from a first position to a second position within the interior space.

9. The container of claim 1, wherein the lock device comprises a receiving device to receive a passcode, the passcode capable of unlocking the door when:
the passcode corresponds to a valid passcode;
the passcode was entered within a predetermined time constraint; and
the number of detected entries of the passcode is less than a predetermined number of entries.

10. The container of claim 1, wherein the processor calculates at least one of a cooling rate and a heating rate, the calculation comprising:
determining the temperature of the interior space when the temperature regulating device is turned on;
periodically measuring the temperature of the interior space of the container and determining an elapsed time between the periodic measurements;
determining a first cooling rate or a first heating rate using the periodic measurements and the elapsed time; and
aggregating the first cooling rate or the first heating rate with an older cooling rate or an older heating rate to obtain the cooling rate or the heating rate.

11. The container of claim 1, wherein the processor selects a temperature regulating process prior to the expected delivery of the object, the selection comprising:
determining an expected delivery temperature;
measuring ambient temperature;
determining temperature control rate data;
determining an expected energy consumption for a first temperature regulating process by factoring the temperature control rate data with the delivery information, the expected delivery time, the expected delivery temperature and the ambient temperature;
calculating an other expected energy consumption of an other temperature regulating process; and
selecting the first temperature regulating process when the expected energy consumption is less than the other expected energy consumption.

12. A container for receiving and storing an object, the container comprising:
a body defining an interior space for receiving an object;
a door for accessing the interior space;
a lock device for unlocking and locking the door;
a temperature regulating device for regulating the temperature of the interior space;
a sensor to indirectly or directly detect whether the object has been placed in the container;
memory; and
a processor configured to cause the container to at least:
detect, using the sensor, the object being placed in the interior space;
regulate the temperature of the interior space;
detect, using the sensor, the object being removed from the interior space; and
deactivate the temperature regulating device.

13. The container of claim 12, wherein the processor is further configured to:
determine if the object is received ahead of or before an expected delivery time; and
turn on or turn off the temperature regulating device if the object is received ahead of or before an expected delivery time.

14. The container of claim 12, wherein the sensor sends output to the processor, the sensor comprising at least one of:
a video camera capable of capturing pictures or video;
a door switch capable of notifying the processor that the door has been opened or closed;
a pressure sensor to detect the weight of the object;
a thermometer to determine the temperature of the interior space or ambient temperature; and
an RFID reader capable of determining if the object is within the interior space.

15. The container of claim 12, wherein the temperature regulating device comprises at least one of a cooling unit to cool the interior space and a heating unit to heat the interior space.

16. The container of claim 12, wherein the container further comprises a communication device capable of exchanging data with an electronic device and a server.

17. The container of claim 12 further comprising a thermally insulated divider, wherein the divider is configured to be moved from a first position to a second position within the interior space.

18. The container of claim 12, wherein the lock device comprises a receiving device to receive a passcode, the passcode capable of unlocking the door when:
the passcode corresponds to a valid passcode;
the passcode was entered within a predetermined time constraint; and
a number of detected entries of the passcode is less than a predetermined number of entries.

19. The container of claim 12, wherein the processor calculates at least one of a cooling rate and a heating rate, the calculation comprising:
determining the temperature of the interior space when the temperature regulating device is turned on;
periodically measuring the temperature of the interior space of the container and determining an elapsed time between the periodic measurements;
determining a first cooling rate or a first heating rate using the periodic measurements and the elapsed time; and
aggregating the first cooling rate or the first heating rate with an older cooling rate or an older heating rate to obtain the cooling rate or the heating rate.

20. The container of claim 12, wherein the processor selects a temperature regulating process after the object is received, the selection comprising:
determining an expected delivery temperature;
measuring ambient temperature;
determining temperature control rate data;
determining an expected energy consumption for a first temperature regulating process by factoring the temperature control rate data with the delivery information, the expected delivery time, the expected delivery temperature and the ambient temperature;
calculating an other expected energy consumption of an other temperature regulating process; and
selecting the first temperature regulating process when the expected energy consumption is less than the other expected energy consumption.
